(19) United States
(12) Patent Application Publication
(10) Pub. No.: US 2007/0258029 A1
(43) Pub. Date: Nov. 8, 2007

(54) Phase Difference Compensator, Light Modurating System, Liquid Crystal Display and Liquid Crystal Projector

(75) Inventors: Kenichi Nakagawa, Shizuoka (JP); Takamichi Fujii, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/792,069

(22) PCT Filed: Dec. 14, 2005
(86) PCT No.: PCT/JP05/23424

§ 371 Date: Jun. 1, 2007

(30) Foreign Application Priority Data
Dec. 15, 2004 (JP) 2004-363305
Dec. 15, 2004 (JP) 2004-363306

(51) Int. Cl. G02F 1/1335; G02B 5/30

(52) U.S. Cl. 349/119; 359/485

(57) ABSTRACT

On a transparent glass substrate (10), a first phase difference compensating layer (12) and a second phase difference compensating layer (14), which are formed of inorganic material, are provided. The first phase difference compensating layer (12) includes a stacked two kinds of deposition films sufficiently thinner than reference wavelength, one has high refraction index, and the other has low refraction index, to be a negative C-plate. The second phase difference compensating layer (14) includes at least two oblique deposition films, to be a positive O-plate. The first phase difference compensating layer (12) compensates a phase difference from liquid crystal molecules in a vertical orientation in a liquid crystal layer, and the second phase difference compensating layer (14) compensates a phase difference from liquid crystal molecules in a hybrid orientation in the liquid crystal layer.

### TECHNICAL FIELD

The present invention relates to a phase difference compensator used between a pair of polarizing elements, in detail, relates to a phase difference compensator improved its view angle dependency, and a light modurating system, a liquid crystal display and a liquid crystal projector with use of this phase difference compensator.

### BACKGROUND ART

To a liquid crystal cell which performs light modulation with use of optical rotation and birefringence in liquid crystal molecules, a polarizing plate as a polarizing element is applied. In a transmissive liquid crystal cell, the polarizing plates are disposed at both a light incident surface side and a light exit surface side of the liquid crystal cell. The polarizing plates are directed perpendicular to an optical axis of the liquid crystal cell. The polarizing plate in the light incident surface side functions as the polarizer which converts non-polarized light into linearly polarized light entering to the liquid crystal cell. The polarizing plate in the light exit surface side functions as an analyzer which blocks or transmits a modulated light from the liquid crystal cell according to a polarization direction of the modulated light. As the polarizing element, a wire grid polarizer is known as same as the polarizing plate. However, in general, the polarizing plate is used. In general, the polarizing plate has a structure in which a PVA (polyvinyl alcohol) film with absorbed iodine and dye is uniaxially oriented and sandwiched between protective layers, and has a transmission axis and an absorption axis which are at right angles to each other in a plane perpendicular to the optical axis. When the non-polarized light enters the polarizing plate, it is split into two polarized light components which are at right angles to each other. The polarized light component parallel to the absorption axis is blocked, and the polarized light component parallel to the transmission axis is transmitted.

The polarizing plate is applied for example to a TN (Twisted Nematic) liquid crystal element. The TN liquid crystal element has superior mass productivity among various operation modes of liquid crystal elements, and is broadly used as an image display device for a direct-view type flat panel display and a liquid crystal projector. The TN liquid crystal element has rodshaped liquid crystal molecules filled between a pair of substrates on which transparent electrodes and orientation films are formed. The liquid crystal molecules constitute a liquid crystal layer. The orientations of long axes of the liquid crystal molecules are kept approximately parallel to the substrates, and rotated gradually around a thickness direction of the liquid crystal layer so that the long axes of the liquid crystal molecules twist smoothly by 90 degrees along a path from one substrate and the other substrate. When no voltage is applied to the liquid crystal layer, the polarization direction of linearly polarized light is rotated by 90 degrees while advancing from one substrate to the other substrate, along with the orientation of the liquid crystal molecules. When a certain level of voltage is applied to the liquid crystal layer, the twisting of the liquid crystal molecules is disappeared, and the liquid crystal molecules near the center of the thickness direction are in a state that the long axis thereof is upraised vertically to the substrate. Accordingly, the polarization direction of linearly polarized light is not changed while advancing from one substrate to the other substrate.

When the one pair of the polarizing plates are disposed between the light incident side and the light exit side of the TN liquid crystal element described above, such that the polarization directions of the polarizing plates are at right angle to each other (cross nicol configuration), an incident light is linearly polarized by the first polarizing plate. When no voltage is applied to the liquid crystal layer, the liquid crystal molecules in the liquid crystal layer are twisted so as to rotate the polarization direction of linearly polarized light by 90 degrees. Linearly polarized light through the liquid crystal layer can pass the second polarizing plate, as a light state (normally white). When a certain level of voltage is applied to the liquid crystal layer, the polarization direction of linearly polarized light is not rotated in the liquid crystal layer, so linearly polarized light is blocked by the second polarizing plate, as a black state. Note that in a case that the pair of the polarizing plate is arranged such that their polarization directions are parallel to each other (parallel nicol configuration), it becomes the dark state when no voltage is applied to the liquid crystal layer (normally black), and it becomes the light state when a certain level of voltage is applied to the liquid crystal layer. Although the TN liquid crystal element can be used in the normally black system, it is practical that the TN liquid crystal element is used in the normally white system, in view of contrast performance.

In addition, the pair of the polarizing plates in the cross nicol configuration can be applied to a polarization microscope and the like. When a sample such as a mineral is positioned between the polarizing plates and the sample is illuminated through a polarizer, if the whole sample has optical isotropy, the linearly polarized light through the polarizer is advanced to an analyzer without changing its polarization direction, and blocked by the analyzer. Accordingly, an observation field of the microscope is dark. However, if there is a crystal structure having optical anisotropy in the sample, the entered linearly polarized light is modulated by birefringence effect of the sample, and then the modulated light passes through the analyzer. Accordingly, the modulated light is observed through the observation field of the microscope.

The TN liquid crystal element has the disadvantage of narrow viewing angle because of birefringence of the liquid crystal molecules. In the TN liquid crystal element of the normally white, birefringence becomes dominant as the applied voltage to the liquid crystal layer increases. Although incident light perpendicular to the liquid crystal element is completely blocked in the black state, the liquid crystal layer exhibits birefringence to oblique incident light to change linearly polarized light into elliptical polarized light. Since elliptical polarized light can pass the second polarizing plate, leakage of incident light causes the decrease in the black density of the selected pixel. Such birefringence of the liquid crystal molecules gradually appears in transition from the white state to the black state, so oblique incident light partially leaks also in gradation displaying. Thus, the contrast ratio of the image on the liquid crystal element decreases if viewed obliquely.

Because of such the view angle property of the TN liquid crystal element, colors and density of black are changed according to an observing direction in the direct-view type flat panel display, and a contrast of a projected image on a screen is reduced in the liquid crystal projector. As known from Japanese Patent Laid-Open Publication No. 2004-102200, such defects can be improved by use of a phase difference compensator composed of two kinds of thin film layers with different refractive indices that are alternately layered, and the optical thickness of each thin film layer is 1/100 to ⅕ of the reference wavelength of light. The phase difference compensator is a negative C-plate. When the linearly polarized light is obliquely entered to the liquid crystal molecules in the vertical orientation for the dark state display, there become an ordinary light and an extraordinary light by the birefringence. The negative C-plate performs as a uniaxial birefringent plate with negative birefringence value, which compensates the phase difference between the ordinary light and the extraordinary light -according to the incident angle. Accordingly, the elliptical polarized light is reshaped to the linearly polarized light, and the leaking of light from the analyzer is prevented. In addition, the phase difference compensator can be formed of inorganic material, which has superior heat-resistance, light-resistance and stability in physically and chemically. Accordingly, this type of the phase difference compensator can be effectively used for the liquid crystal projector, as same as the direct-view type liquid crystal display.

U.S. Pat. No. 5,638,197 describes that an O-plate is effective to improve the view angle property of the TN liquid crystal element. The O-plate is a birefringence body in which a main optical axis is oblique to a reference plane (such as the substrate of the liquid crystal). In the direction of the main optical axis, the birefringence is not induced. The O-plate can be easily formed by depositing the inorganic material to the substrate from an oblique direction (oblique deposition). In addition, the O-plate can be used in combination with the C-plate and A-plate.

Hiroyuki MORI et al. “Development of WideView SA, a Film Product Widening the Viewing Angle of LCDs” FUJIFILM RESEARCH & DEVELOPMENT No. 46-2001 p 51-55 discloses the WV film formed such that a discotic compound is fixed in a hybrid orientation on a TAC film as a base. The WV film is already putted to practical use. When in the dark state display, although most of the liquid crystal molecules distributed in the thickness direction of the liquid crystal-layer become the vertical orientation, but the liquid crystal molecules near the substrates become the hybrid orientation. That is, the long axes of the liquid crystal molecules are gradually uprising to the vertical orientation from an orientation parallel to the substrates, according to a distance from the substrates. The birefringence body of Japanese Patent Laid-Open Publication No. 2004-102200 cannot effectively compensate the phase difference by the liquid crystal molecules in the hybrid orientation. However, the WV film can effectively compensate also the phase difference by the liquid crystal molecules in the hybrid orientation, because the discotic compound is in the hybrid orientation as described above.

When the pair of polarizing plates (the polarizer and the analyzer) in the cross nicol configuration is used in the polarization microscope or the like, a sufficient light shielding property cannot be obtained in certain view angles for observing the sample through the analyzer. If all of the luminous flux of the incident light from the polarizer are parallel to the optical axis, there is no ray emanating from the analyzer. However, in reality, the luminous flux from the general light sources includes ray inclined from the optical axis; because of divergence of light. For example, a metal halide lamp, ultrahigh pressure mercury lamp or the like with a reflector is applied to the liquid crystal projector or the like. The light from these light sources includes many fluxes inclined from the optical axis. This type of the incident light cannot be sufficiently shielded by use of only the pair of polarizing plates in the cross nicol configuration.

In FIG. 33, points of equal relative brightness value of the emanated light from the analyzer are connected. A center of the graph corresponds to 0° view angle, concentric circles show respective view angles, and each angle described along an outer periphery of the graph show each azimuth of the observing direction. The graph shows that the relative brightness value becomes higher according to that the view angle becomes larger. When the view angle is over 60°, 10% or more of the incident light is observed. The observed light is a leak light. In addition, since the absorption axes of the pair of polarizing plates, which have 0° and 90° azimuth, are perpendicular to each other, the leakage of the light becomes maximized at a position 45° from the absorption axis, and the light shielding property have rotational symmetries through 90° according to the azimuth.

It is known that various types of the phase difference compensator can be disposed on an optical path between the pair of polarizing plates in the cross nicol configuration, to improve the light shielding property, especially the view angle property of the polarizing plate. Claire Gu & Pochi Yeh “Extended Jones matrix method. II” Journal of Optical Society of America A/Vol. 10 No. 5/May 1993 p 966-973 discloses that phase difference compensators formed of combinations of C-plate and A-plate, especially a combination of a positive C-plate and ¼ wavelength plate and a combination of a negative C-plate and ¾ wavelength plate are effective to improve the view angle property of the pair of polarizing plates in the cross nicol configuration.

In regard to the phase difference compensator of Japanese Patent Laid-Open Publication No. 2004-102200, that can effectively compensate the phase difference caused by the incident light obliquely entering the liquid crystal molecules in the vertical orientation when the TN liquid crystal element is used for the dark state display in the normally white mode. However, as described above, that cannot perform the effective phase difference compensating for the liquid crystal molecules in the hybrid orientation. In regard to the O-plate of U.S. Pat. No. 5,638,197 which is formed of single oblique deposition film, that is not in practical use because of lack of knowledge for optimizing its structure to be used by itself or combining with the C-plate or the like, so as to obtain the desired view angle property. In regard to the WV film of “Development of WideView SA”, that can perform the effective phase difference compensation for the direct-view type liquid crystal display and the like. However, there are many problems for giving a 10,000 hours or more endurance time to the WV film when being applied to the liquid crystal projector and the like in which the film is exposed for long hours to high-intensity light including short-wavelength light.

To solve these problems, it is ideal to give the hybrid orientation to the phase difference compensator of Japanese Patent Laid-Open Publication No.2004-102200. However, producing and utilizing the phase difference compensator formed of the inorganic material with the hybrid orientation is very difficult. It is also ideal to combine the negative C-plate of Japanese Patent Laid-Open Publication No. 2004-102200 and the O-plate of U.S. Pat. No. 5,638,197. However, this concept is not commercialized because of lack of knowledge relate to concrete configuration and practical effects thereof.

To improve the view angle property of the pair of polarizing plates in the cross nicol configuration, the phase difference compensator formed of the combination of the C-plate and the A-plate, as described in “Extended Jones matrix method. II”, is effective. However, in the past, this type of the phase difference compensator can be formed only when using a polymer film which is uniaxially drawn. Such organic material has problems of temperature dependency and hygroscopic property, and whose optical property is easy to change by longtime use or use environment. In addition, in reality, if the view angle is 60° or more, approximately 10% of the incident light is leaked. Note that in principal, a phase difference compensator formed of a combination of two optically biaxial phase difference plates is known. However, the optically biaxial phase difference plate can be formed only when using the polymer film, and the forming process is very difficult.

An object of the present invention is to provide a phase difference compensator which can effectively compensate phase difference caused by liquid crystal molecules in hybrid orientation and be produced efficiently for reducing cost, and to provide a liquid crystal projector effectively using the phase difference compensator.

Another object of the present invention is to provide a phase difference, compensator which has an improved light shielding property and an improved view angle dependency for a pair of polarizing plates in a cross nicol configuration, and to provide a light modulating system and a liquid crystal projector effectively using the phase difference compensator.

### DISCLOSURE OF INVENTION

In order to achieve the above objects and other objects, a phase difference compensator of a first embodiment of the present invention comprises: a first phase difference compensating layer including multi-layer films each of which is a form birefringence body formed of inorganic material, for compensating phase difference caused by liquid crystal molecules in vertical orientation in a liquid crystal layer; and a second phase difference compensating layer including multi-layer films each of which is a form birefringence body formed of inorganic material, for compensating phase difference caused by liquid crystal molecules in hybrid orientation in the liquid crystal layer. It is preferable that at least one of the first and second phase difference compensating layers includes multi-layer films each of which is formed by vacuum deposition method. It is preferable that the second phase difference compensating layer includes plural kinds of stacked oblique deposition films which are different in at least one of an azimuth and a polar angle of a deposition direction toward a deposition surface. It is preferable that the second-phase difference compensating layer includes three or more stacked oblique deposition films. It is not required that both the azimuth and the polar angle of the deposition direction of the one oblique deposition film are different from those of the other oblique deposition films. However, it is required that a combination of the azimuth and the polar angle of the deposition direction of the one oblique deposition film is different from that of the other oblique deposition films. Note that it is preferable that the lamination number of the oblique deposition films is ten or less, in consideration of total thickness and productivity of the second phase difference compensating layer.

The azimuth of the deposition direction of the each oblique deposition films is determined to be different from an azimuth of the liquid crystal molecules given by an orientation film of a TN liquid crystal cell. When each optical axis vector is determined from the azimuth, the polar angle and a retardation of the each oblique deposition film, and a synthetic vector A of the optical axis vectors is orthogonally projected on a deposition surface parallel to a support such as the transparent substrate or a substrate of the TN liquid crystal cell, x and y coordinate value (Ax, Ay) satisfies following formulae:
−200 nm≦Ax≦200 nm and
−500 nm≦Ay≦0 nm

It is preferable that a relation between a retardation din of the first phase difference compensating layer and a product (dΔn)_{LC} of the birefringence and a thickness d of the liquid crystal layer of the TN liquid crystal cell is as follows:
−2×(dΔn)_{LC}≦(dΔn)≦−0.5×(dΔn)_{LC}

The first phase difference compensating layer is composed of two kinds of deposition films with different refractive indices that are alternately layered, and an optical thickness of each of the deposition films is 1/100 to ⅕ of a reference wavelength, which is sufficiently thinner than the optical thickness of general optical thin films using the effect of interference of light. It is preferable that an anti-reflection layer is provided at a light incident surface side and/or a light exit surface side of the phase difference compensator, so as to prevent an interface reflection of the phase difference compensator.

The phase difference compensator of the first embodiment can be applied to liquid crystal display devices, such as a direct-view type liquid crystal display with the TN liquid crystal cell, preferably a liquid crystal projector. When the phase difference compensator is applied to a three-panel type color liquid crystal projector comprising three TN liquid crystal cells corresponding to each of three component color lights, the three phase difference compensators each of which corresponds to the each TN liquid crystal cell includes at least two kinds of the phase difference compensators each of which has a retardation different from each other according to a reference wavelength of the each component color light. Note that as the liquid crystal projector including the phase difference compensator, there both may be a front projector in which an image is projected from a front side of a screen, and a rear projector in which an image is projected from a rear side of a screen.

In order to achieve the above objects and other objects, a phase difference compensator of a second embodiment of the present invention, which is used between a pair of polarizing elements in a cross nicol configuration, comprises: a transparent substrate vertical to an optical axis which is vertical to a pair of polarizing elements, a first phase difference compensating layer supported by the transparent substrate with optical axis thereof being vertical to the transparent substrate, and a second phase difference compensating layer including three or more stacked films each of which has an optical axis inclined to a normal of the transparent substrate, directions of said optical axes of two of said stacked films orthogonally projected on said transparent substrate being approximately 180° apart from each other. Note that each optical axis has an optical isotropy, and corresponds to a direction of an incident light in which refractive indices of an ordinary light beam and an extraordinary light beam become equal. In addition, the first and second phase difference compensating layers can be formed of inorganic material.

The first and second phase difference compensating layers can be efficiently produced from a deposition film formed by deposition or sputtering. The first phase difference compensating layer is composed of two kinds of deposition films with different refractive indices that are alternately layered, and an optical thickness of each of the deposition films is 1/100 to ⅕ of a reference wavelength, which is sufficiently thinner than the optical thickness of general optical thin films using the effect of interference of light.

It is effective that a direction of an optical axis of one of the layered film in the second phase difference compensating layer is same to a direction of a transmission axis of the polarizing element in a light incident side of the phase difference compensator. In addition, an anti-reflection layer can be provided at a light incident surface side and/or a light exit surface side of the phase difference compensator. When the phase difference compensator is applied to a light modulating system including a liquid crystal cell, it is preferable that the phase difference compensator is disposed at a light incident surface side of the liquid crystal cell. As the liquid crystal cell, both a transmissive type and a reflective type can be used. When the reflective type liquid crystal cell is used, a modulated light from the liquid crystal cell is entered to a projection lens in off-axis, and projected on a screen.

According to the phase difference compensator of the first embodiment of the present invention, since the second phase difference compensating layer for compensating phase difference caused by the liquid crystal molecules in hybrid orientation is formed of the multi-layer films each of which is the form birefringence body, the effective phase difference compensation can be performed. At least one of the first and second phase difference compensating layers can be efficiently produced by including multi-layer films each of which is formed by vacuum deposition method. Since the second phase difference compensating layer includes plural kinds of stacked oblique deposition films which are different in at least one of the azimuth and the polar angle of the deposition direction toward the deposition surface, the effective phase difference compensation can be performed. And when the phase difference compensator is applied to the TN liquid crystal element used in a normally white mode, a contrast of a displayed image is improved because leak light in a dark state display caused by oblique incident light is sufficiently reduced. Since the first and second phase difference compensating layer are formed of inorganic material, which has superior heat-resistance, light-resistance and stability in physically and chemically, the phase difference compensator can be applied to the liquid crystal projector including a high-intensity light source, as same as the liquid crystal display such as a direct-view type liquid crystal monitor or the like. Since the first phase difference compensating layer is formed of the deposition film of the inorganic material as same as the second phase difference compensating layer, the first and second phase difference compensating layer can be efficiently produced in a same process.

According to the phase difference compensator of the first embodiment of the present invention, the first phase difference compensating layer whose optical axis is vertical to the transparent substrate is thought to perform as a C-plate for compensating the phase difference according to an incident angle of the oblique incident light. In addition, the second phase difference compensating layer including multi-layer films having respective optical axes directed various direction is thought to perform as a complex O-plate for rotating a polarization direction of a linearly polarized light according to an incident angle of the incident light. By synergy of these effects of the first and second phase difference compensating layers, a view angle property of a light modulating optical system, including the pair of the polarizing elements in the cross nicol configuration, can be improved. In addition, it was experimentally found that when directions of the optical axes of two of the stacked films are approximately 180° apart from each other, the view angle property is further improved. Preferably, the two optical axes are 180°±50 apart from each other, particularly 180°±20 apart from each other, and especially 180° apart from each other.

When a direction of an optical axis of one of the layered film in the second phase difference compensating layer is same to the direction of the transmission axis of the polarizing element, the effective light shielding can be performed. When both the first and second phase difference compensating layers are formed of inorganic material, especially of the deposition films, the phase difference compensator has superior heat-resistance, light-resistance and mass productivity.

The phase difference compensator of the second embodiment can be applied to various light modulating systems including the pair of polarizing element in the cross nicol configuration, preferably liquid crystal display such as the direct-view type liquid crystal monitor, and the liquid crystal projector in which the image is projected on the screen after modulated by the liquid crystal cell. As the liquid crystal cell, the reflective type in off-axis can be used as same as the transmissive type. In addition, as the projector, both a front projection type and a rear projection type can be used.

### BRIEF DESCRIPTION OF DRAWINGS

FIG. 1 is a schematic view of a liquid crystal display with use of a phase difference compensator of a first embodiment of the present invention;

FIG. 2 is a cross-sectional view of the phase difference compensator of the first embodiment;

FIG. 3 is a schematic view of a configuration of a first phase difference compensating layer;

FIG. 4 is a schematic view of a configuration of a second phase difference compensating layer;

FIG. 5 is a schematic view of a deposition device for forming an oblique deposition film;

FIG. 6 is an explanatory view showing an azimuth and a polar angle of the oblique deposition film;

FIG. 7 is an explanatory view showing an optical axis vector of the oblique deposition film;

FIG. 8 is an explanatory view showing a configuration of a TN liquid crystal element;

FIG. 9 is an explanatory view showing a synthetic vector;

FIG. 10 is a contrast ratio curve sheet of the TN liquid crystal element;

FIG. 11 is a contrast ratio curve sheet of the TN liquid crystal element with the phase difference compensator of Experiment 1;

FIG. 12 is a contrast ratio curve sheet of the TN liquid crystal element with the phase difference compensator of Experiment 2;

FIG. 13 is a contrast ratio curve sheet of the TN liquid crystal element with the phase difference compensator of Experiment 3;

FIG. 14 is a contrast ratio curve sheet of the TN liquid crystal element with the phase difference compensator of Experiment 4;

FIG. 15 is a contrast ratio curve sheet of the TN liquid crystal element with the phase difference compensator of Experiment 5;

FIG. 16 is a contrast ratio curve sheet of the TN liquid crystal element with the phase difference compensator of Experiment 6;

FIG. 17 is a schematic view of a three-panel type color liquid crystal projector with use of the phase difference compensator of the first embodiment;

FIG. 18 is a chart showing wavelength dependency of retardation of the TN liquid crystal element;

FIG. 19 is a chart showing wavelength dependency of retardation of the first phase difference compensating layer;

FIG. 20 is a graph showing retardation properties of the TN liquid crystal element and the first phase difference compensating layer;

FIG. 21 is a chart showing wavelength dependency of retardation of the improved first phase difference compensating layer;

FIG. 22 is a graph showing retardation properties of the improved first phase difference compensating layer;

FIG. 23 is a schematic view of an optical system for checking function of a phase difference compensator of a second embodiment of the present invention;

FIG. 24 is a cross-sectional view of the phase difference compensator of the second-embodiment;

FIG. 25 is a schematic view of a configuration of a second phase difference compensating layer;

FIG. 26 is an explanatory view showing an azimuth and a polar angle of an oblique deposition film;

FIG. 27 is an explanatory view showing a projected vector which is an optical axis vector orthogonally projected on an x-y plane;

FIG. 28 is a brightness curve chart showing a light shielding property of the phase difference compensator of Experiment 7;

FIG. 29 is a brightness curve chart showing a light shielding property of a comparable sample of the phase difference compensator;

FIG. 30 is a schematic view of a liquid crystal display with use of a transmissive type TN liquid crystal element in which the phase difference compensator of the second embodiment is applied;

FIG. 31 is a schematic view of a liquid crystal display with use of a reflective type TN liquid crystal element in which the phase difference compensator of the second embodiment is applied;

FIG. 32 is a schematic view of a three-panel type color liquid crystal projector with use of the phase difference compensator of the second embodiment; and

FIG. 33 is a brightness curve chart showing a light shielding property of a pair of polarizing plates in a cross nicol configuration, when using a general light source.

### BEST MODE FOR CARRYING OUT THE INVENTION

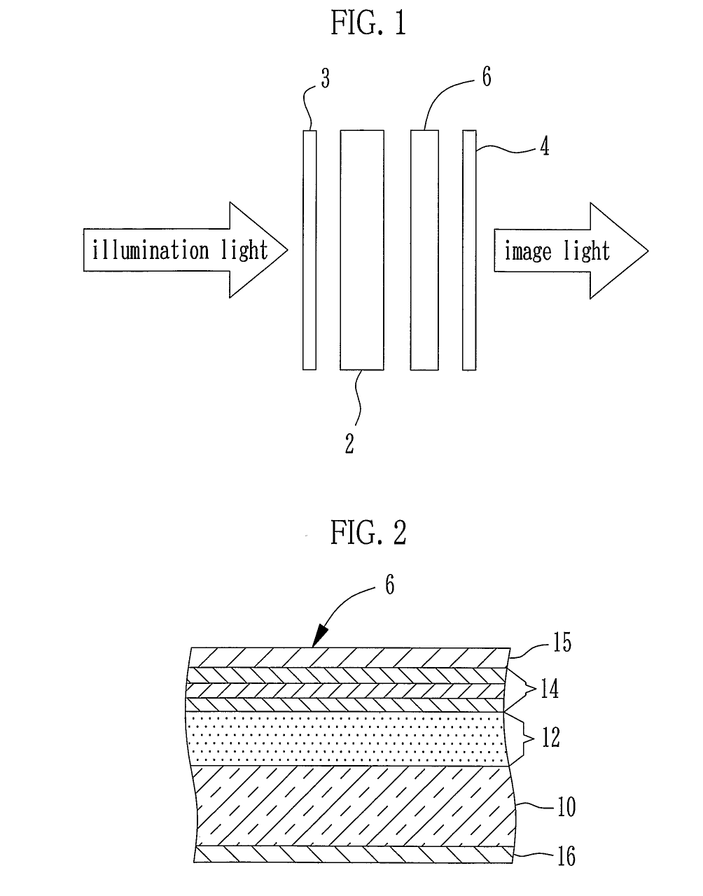

A phase difference compensator of a first embodiment of the present invention is now described. A liquid crystal display with use of the phase difference compensator has a conceptual structure as shown in FIG. 1. Polarizing plates 3, 4 are respectively disposed at a light incident surface side and a light exit surface side of a TN liquid crystal element 2. The polarization axes of the polarizing plates 3 and 4 used in a normally white mode are perpendicular to each other (cross nicol configuration). The polarizing plate 3 is a polarizer which converts illumination light into linearly polarized light. The polarizing plate 4 is an analyzer which transmits a part of the light modulated by the TN liquid crystal element 2, whose polarization direction corresponds to that of the polarizing plate 4, and shields a remaining light from the TN liquid crystal element 2.

Between the TN liquid crystal element 2 and the polarizing plate 4, the phase difference compensator 6 of the first embodiment of the present invention is mounted. Liquid crystal molecules of the TN liquid crystal element 2 has a birefringence effect, which converts the linearly polarized light into various elliptical polarized light according to the orientation of the liquid crystal molecules and the incident angle of the illumination light. Accordingly, there is a possibility to occur that a part of the light for being shielded at the polarizing plate 4 is overlapped on the image light. The phase difference compensator 6 compensates the phase difference between the ordinary light and the extraordinary light generated by the birefringence effect of the liquid crystal molecules, to reversely convert the elliptical polarized light into linearly polarized light. Since constituted by a thin film formed by deposition of inorganic material, the phase difference compensator 6 includes a transparent substrate such as a glass substrate as a support. Note that a transparent substrate of the TN liquid crystal element 2 and a transparent substrate of the polarizing plate 4 may be used as the support. Note that the phase difference compensator 6 may be mounted between the TN liquid crystal element 2 and the polarizing plate 3 to perform the same effect.

As shown in FIG. 2, the phase difference compensator 6 has a first phase difference compensating layer 12 and a second phase difference compensating layer 14 superimposed on one side of a glass substrate 10 as the support, and anti-reflection layers 15,16 respectively formed on the second phase difference compensating layer 14 and on the other side of the glass substrate 10. The anti-reflection layers 15, 16 are for preventing surface reflection. As the anti-reflection layer, for example a single layer film having λ/4 optical thickness formed from MgF₂ having a low-refractive index, can be used. In addition, an anti-reflection film having plural layers formed from different deposition materials can be used. Note that when the first and second phase difference compensating layers 12, 14, and anti-reflection layers 15, 16 are formed of deposition films, vacuum deposition method by resistance heating or electron beam heating, or sputtering deposition method can be used. The relative position of the first phase difference compensating layer 12 and the second phase difference compensating layer 14 can be reversed without reducing their optical effect, and can be formed on each side of the glass substrate 10.

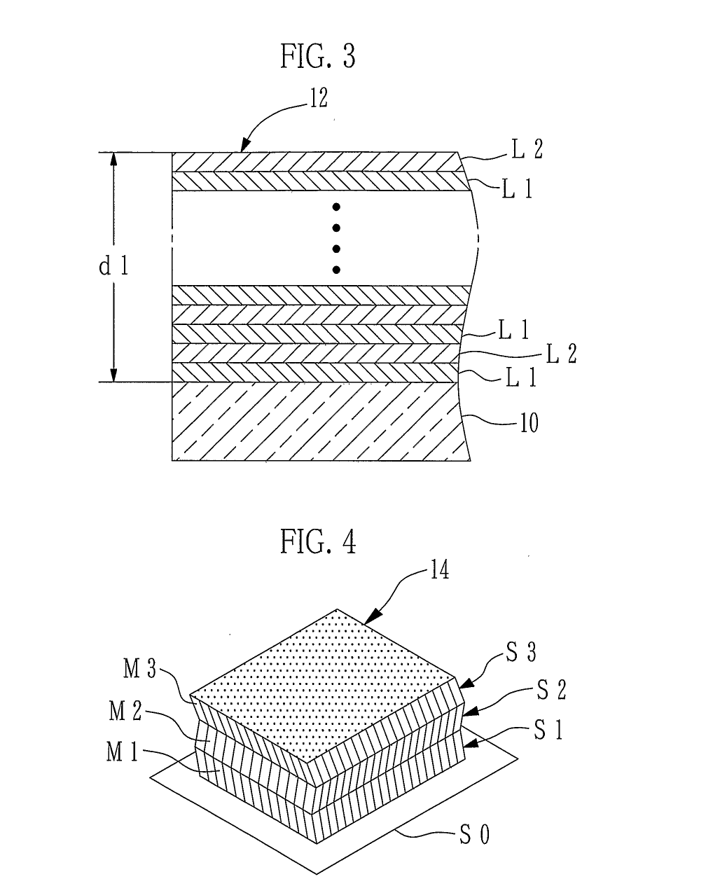

As shown in FIG. 3, the first phase difference compensating layer 12 comprises plural thin films L1, L2 that are alternatively stacked on the glass substrate 10. The refractive indices of the thin films L1, L2 are different from each other. Each deposition direction is perpendicular to the deposition surface. The optical thickness (the product of the physical thickness and the refractive index) of each thin film is sufficiently smaller than the wavelength λ of incident light (for example 550 nm). The optical thickness of each thin film is preferably from λ/100 to λ/5, more preferably from λ/50 to λ/5, and practically from λ/30 to λ/10, which is quite thinner than general optical thin films using optical interference. The formed multi-layer film is negative birefringence of the c-plate (uniaxial birefringent plate). Other types of the first phase difference compensating layer 12 which is negative birefringence of the c-plate, and which is not the multi-layer film, can be used.

The first phase difference compensating layer 12 is designed as follows. As described in the publication, Kogaku (Japanese Journal of Optics), vol. 27, no. 1 (1998), pp. 12-17, the birefringence Δn is defined as the ratio of optical thicknesses of two deposition films L1, L2 with different refractive indices. The birefringence Δn becomes large as the difference in refractive indices. The retardation d·Δn is defined as the product of the birefringence Δn and the total physical thickness d of the first phase difference compensating layer 12. The ratio of optical thicknesses of two films is designed so as to obtain a large birefringence Δn. Then, the total physical thickness d of the first phase difference compensating layer 12 is determined based on the desired retardation d·Δn.

A sample of a multi-layer deposition film is prepared by depositing 40 TiO₂ layers and 40 SiO₂ layers alternatively on the glass substrate 10. The physical thickness of each layer is 15 nm. A spectroscopic ellipsometer is used to measure the retardation of the sample. As a result, the sample exhibits negative birefringence with the retardation of 208 nm, and the ordinary optical axis (the axis with no optical anisotropy) of the sample is perpendicular to the glass substrate 10. Accordingly, it is clear that the sample performs as a negative c-plate.

As the deposition materials for the deposition films L1, L2, examples of the materials for the high-refractive index thin film are TiO₂ (2.20 to 2.40) and ZrO₂ (2.20). The numerical value in the parentheses indicates the refractive index. Examples of the materials for the low-refractive index thin film are SiO₂ (1.40 to 1.48), MgF₂ (1.39) and CaF₂ (1.30). As the deposition materials for the deposition films L1 and L2, it is possible to use the materials, such as CeO₂ (2.45), Nb₂O₅ (2.31), SnO₂ (2.30), Ta₂O₅ (2.12), In₂O₃ (2.00), ZrTiO₄ (2.01), HfO₂ (1.91), Al₂O₃ (1.59 to 1.70), MgO (1.70), AlF₃, diamond thin film, LaTiOₓ and samarium oxide. Examples of the combinations for high and low-refractive index thin films are TiO₂/SiO₂, Ta₂O₅/Al₂O₃, HfO₂/SiO₂, MgO/Mgf₂, ZrTiO₄/ Al₂O₃, CeO₂/CaF₂, ZrO₂/SiO₂ and ZrO₂/Al₂O₃.

The plural deposition films L1, L2 are deposited by use of deposition device. The deposition device has shutters to shield the glass substrate 10 from the source materials. The shutters are alternatively open and close so that the two deposition films L1, L2 are alternatively deposited on the glass substrate 10. Instead of the shutters, the glass substrate 10 may be held on a holder that moves the substrate at a predetermined speed. The two deposition films L1, L2 are alternatively deposited by passing the substrate above the evaporated source materials. Since the deposition device requires a single vacuum process in order to obtain plural thin films, it is possible to increase the productivity.

The second phase difference compensating layer 14 is a stacked layers having O-plate function formed from inorganic compounds. As the producing method, there are oblique deposition, photolithography as described in Japanese Laid-Open Patent Publication 2004-212468, alignment of rodshaped molecules, and the like. The oblique deposition is most preferable in view of productivity. The second phase difference compensating layer 14 formed by the oblique deposition is described below. When using the oblique deposition, the first and second phase difference compensating layers can be formed by same vacuum method.

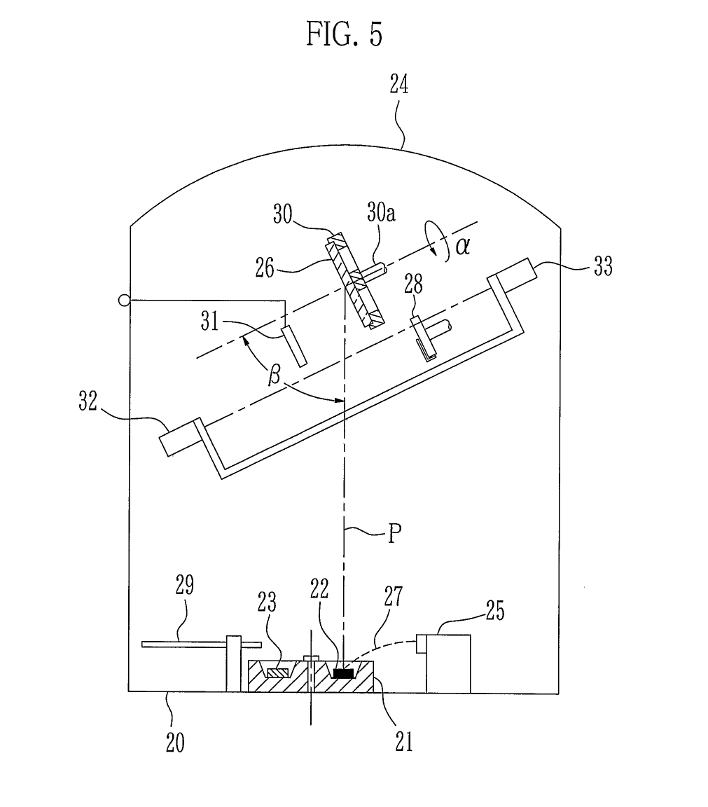

As shown in FIG. 4, the second phase difference compensating layer 14 has three stacked oblique deposition films S1, S2, S3. As shown in FIG. 2, the first oblique deposition film S1 is stacked on the first phase difference compensating layer 12. However, it is possible that the positions of the first and second phase difference compensating layers 12 and 14 are interchanged, such that the first oblique deposition film S1 is formed on the glass substrate 10, the second and third oblique deposition films S2 and S3 are sequentially formed on the first oblique deposition film S1, and then the first phase difference compensating layer 12 is formed on the third oblique deposition film S3. In addition, it is also possible that the first phase difference compensating layer 12 and the second phase difference compensating layer 14 are respectively formed on both sides of the glass substrate 10, and the anti-reflection layers 15 and 16 are respectively formed on outermost layers of the first and second phase difference compensating layers 12, 14.

Different from the deposition films L1 and L2 of the first phase difference compensating layer 12, the oblique deposition films S1 to S3 of the second phase difference compensating layer 14 are deposited from oblique direction toward a deposition surface S0. Each of the deposition films S1 to S3 respectively has microscopic columnar elements M1 to M3 which are obliquely extended toward whose deposition direction. As shown in FIG. 4, the extension directions of these columnar elements M1 to M3 are not parallel with each others. Each of oblique deposition films S1 to S3 as single layer can show form birefringence effect and can be used as O-plate having positive birefringence. However, in the second phase difference compensating layer 14 of the present invention, the plural oblique deposition films are stacked to obtain unique optical effects.

The oblique deposition films S1 to S3 can be formed for example by the deposition device shown in FIG. 5. A material holder 21 which rotates in a turret manner is provided on a base plate 20. In the material holder 21, deposition materials 22, 23 are contained. After vacuuming a vacuum chamber 24, a electron gun 25 radiates a electron beam 27 toward the deposition material 22, to vaporize the deposition material 22. Accordingly, the vacuum deposition can be performed. A shutter 29 opens and closes the material holder 21 to start and stop the vacuum deposition. The material holder 21 rotates to select one of the deposition material 22, 23 for the deposition. Basically, the second phase difference compensating layer 14 is formed of plural film layer from one deposition material. However, by use of the material holder 21, plural deposition materials can be used according to need.

Above the material holder 21, a substrate holder 30 is provided obliquely, which supports a sample substrate 26. A normal to a supporting surface of the substrate holder 30 is inclined an angle β to a line P vertically extended from the deposition material 22. Accordingly, the deposition surface of the sample substrate 26 is also inclined the angle β to the line P. The angle β can be controlled by rotating the substrate holder 30 around an axis perpendicular to an axis 30a. In addition, an angle a corresponding to an azimuth of the line P in the deposition surface can be controlled by rotating the substrate holder 30 around the axis 30a. Since the line P corresponds to a deposition direction toward the deposition surface, the deposition direction toward the deposition surface can be controlled in two-way by changing the angles α and β. As described above, the angle α corresponds to the azimuth of the deposition direction in the deposition surface, and the angle β corresponds to a polar angle representing the inclination of the deposition direction toward the deposition surface. Accordingly, hereinafter the angle α is called as the azimuth α, and the angle β is called as the polar angle β.

A film thickness monitor of quartz crystal type 31 monitors a thickness of the deposition film on a measuring plane to relatively measure the thickness of the deposition film on the sample substrate 26. An ellipsometer 32 receives a measuring light from a light emitter 33 through a monitor substrate 28 to relatively measure a phase difference accompanying with the birefringence, while forming the oblique deposition film. The measuring plane of the film thickness monitor 31 and the phase difference measuring system including the monitor substrate 28 can be rotated to correspond to the polar angle β of the substrate holder 30. In addition, by displacement of mask plate, new clean surfaces of the measuring plane and the monitor substrate can be exposed every finishing the form of each layer of the oblique deposition film. Accordingly, the phase difference of each one layer of the oblique deposition film can be monitored. The retardation of the oblique deposition film can be estimated from the data of the phase difference measured by the ellipsometer 32. Therefore, the oblique deposition film including plural layers each of which has desired retardation can be obtained by performing the deposition with monitoring the data from the ellipsometer 32 and the film thickness monitor 31.

According to above-described processes, the second phase difference compensating layer comprising the multi-layer oblique deposition film can be formed on the sample substrate 26 with monitoring the phase difference of each one layer. And in case that at first the first phase difference compensating layer 12 is formed on the glass substrate 10 as shown in FIG. 2, the multi-layer second phase difference compensating layer 14 can be formed on the first phase difference compensating layer 12 by holding the glass substrate 10 on the substrate holder 30 and performing the oblique deposition such that each layer has the pre-designed retardation.

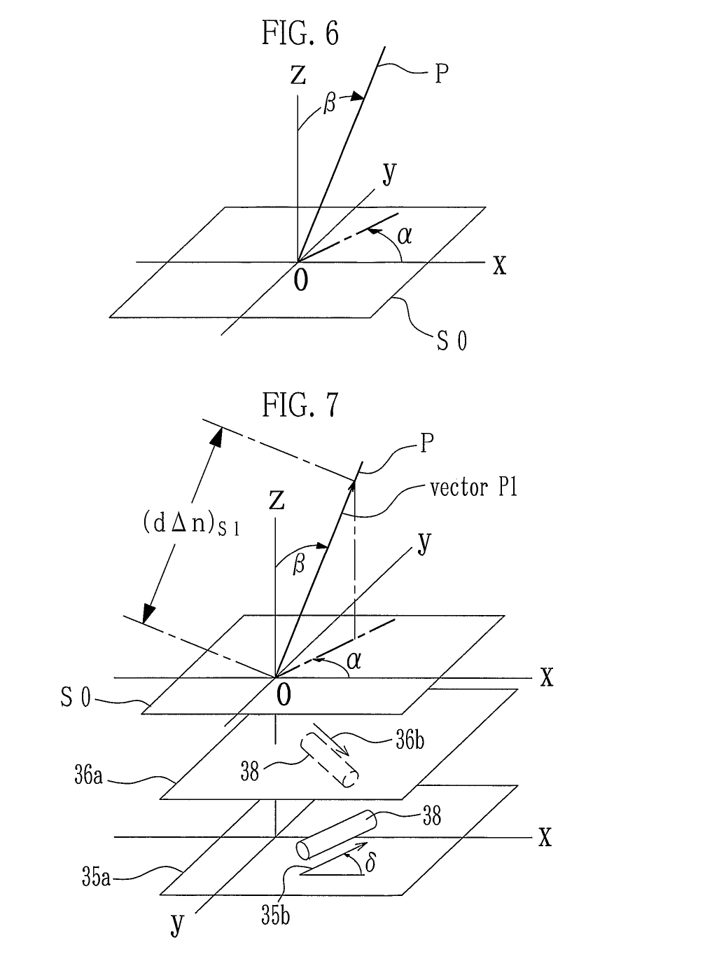

As shown in FIG. 6, the deposition direction P toward the deposition surface SO is represented by the azimuth α measured from an X-axis in counterclockwise direction and the polar angle β measured from a Z-axis, when orthogonally projected on an X-Y coordinate on the deposition surface SO. The polar angle β is an inclination angle from the Z-axis without directionality of positive and negative, and the azimuth α has directionality with reference to the X-axis.

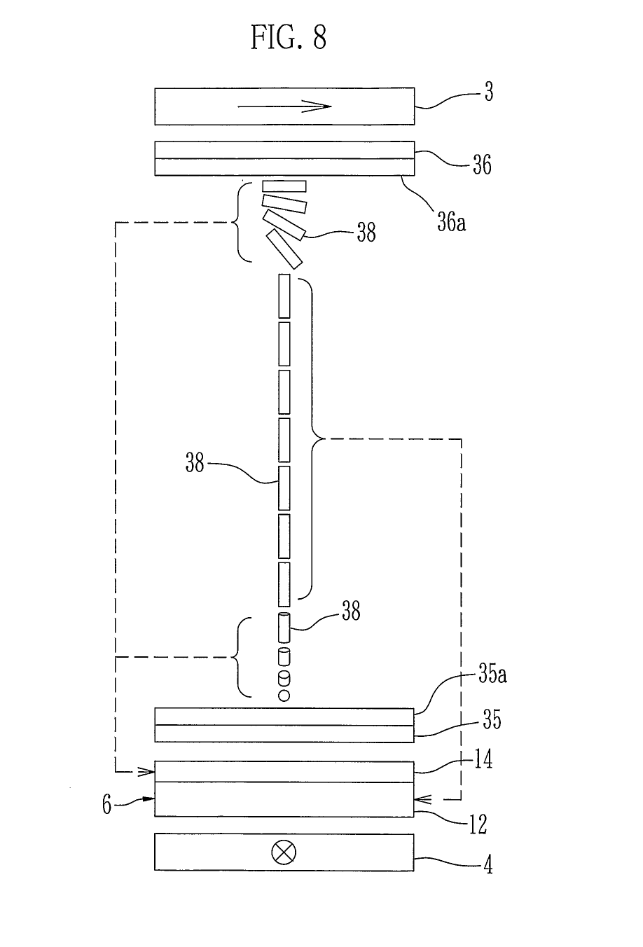

As shown in FIG. 8, inside substrates 35, 36 of the TN liquid crystal element 2, orientation films 35a, 36a are provided for giving 90° twisted orientation to the liquid crystal molecules 38. The orientation film 35a gives the liquid crystal molecules 38 an orientation parallel to the paper on which FIG. 8 is illustrated. The orientation film 36a gives the liquid crystal molecules 38 an orientation perpendicular to the paper. Polarization directions of the polarizing plates 3, 4 are respectively adjusted to the respective orientation of the orientation films 35a, 36a. When saturation voltage is applied, as shown in FIG. 8, the liquid crystal molecules 38 distributed in center area in thickness direction of the cell are in vertical orientation. However, near the substrates 35, 36, there are areas where the tilt angle of the liquid crystal molecules 38 is continuously varied. The first phase difference compensating layer 12 of the phase difference compensator 6 compensates the phase difference by the birefringence effect of the liquid crystal molecules 38 in the vertical orientation. The second phase difference compensating layer 14 compensates the phase difference by the birefringence effect of the liquid crystal molecules 38 in the areas where the tilt angle thereof is continuously varied, that is, in a hybrid orientation.

The orientation direction of the liquid crystal molecules 38 is dependent on the rubbing direction for making the orientation films 35a and 36a. As shown in FIG. 7, the rubbing process is applied to the orientation films 35a, 36a in directions shown as arrows 35b and 36b. According to that, the orientation direction of the liquid crystal molecules 38 is determined. Note that the X-Y-Z coordinate systems in the FIGS. 6, 7 are defined in same direction in the space. The direction of the X-axis is determined such that the rubbing direction 35b of the orientation film 35a has an angle δ=45° from the X-axis. Accordingly, the rubbing direction 36b of the orientation film 36a corresponds to a direction −45° from the X-axis. When the voltage is applied to the TN liquid crystal element 2 in this arrangement, a long axis of the liquid crystal molecule distributed in the center area in the thickness direction of the liquid crystal cell is moved within the Y-Z plane, and the tilt angle thereof is moved within from the positive direction of the Y-axis to the positive direction of the Z-axis.

The deposition direction P approximately corresponds to an optical axis of the oblique deposition film S1. The oblique deposition film S1 has O-plate property showing form birefringence effect. However, the oblique deposition film S1 shows optical isotropy to a light parallel to the direction of the columnar element M1. However, the optical axis is entered in the film S1 with refraction at the interface between a medium whose refractive index is 1 (such as air) and the film S1, then corresponds to the direction of the columnar element M1. That is, the optical axis is inclined at an angle according to the refractive index of the oblique deposition film, from the direction of the columnar element. Therefore, the deposition direction P and the optical axis are not exactly same direction, in a precise sense.

Accordingly, an optical axis vector P1 is determined from a deposition direction P, which is defined by the azimuth α and the polar angle β when an origin O is the base point, and a retardation (dΔn)ₛ₁, which is defined by the film thickness and the birefringence of the oblique deposition film S1. As same as the optical axis vector P1 of the oblique deposition film S1, optical axis vectors P2, P3 of the oblique deposition films S2, S3 are determined. Generally, the optical axis vector Pi is shown as follows by combination of the retardation (dΔn)_{Si}, the azimuth αᵢ and the polar angle βᵢ:
Pi(x, y, z)=((dΔn)ₛᵢ×cos αᵢ×tan βᵢ, (dΔn)ₛᵢ×sin αᵢ×tan βᵢ, (dΔn)ₛᵢ)
Note that subscript i in the above figure shows the number of the oblique deposition film (such as S1, S2, S3). A synthetic vector A of these optical axis vectors Pi is shown as follows:
A=ΣPi
The synthetic vector A corresponds to a mean vector of the multi layer oblique deposition film weighted by the retardation (dΔn)ₛᵢ of the each layer.

To form the second phase difference compensating layer 14 with three layers, there are various combinations of the oblique deposition films S1 to S3, which depend on how to determine the optical axis vector P1 to P3 and selection of the retardation (dΔn)ₛᵢ, the azimuth αᵢ and the polar angle βᵢ to obtain the optical axis vector P1 to P3. In the present invention, a basis of valuation is x and y coordinate value (Ax, Ay) when the synthetic vector A is orthogonally projected on the deposition surface S0, to optimize the second phase difference compensating layer 14.

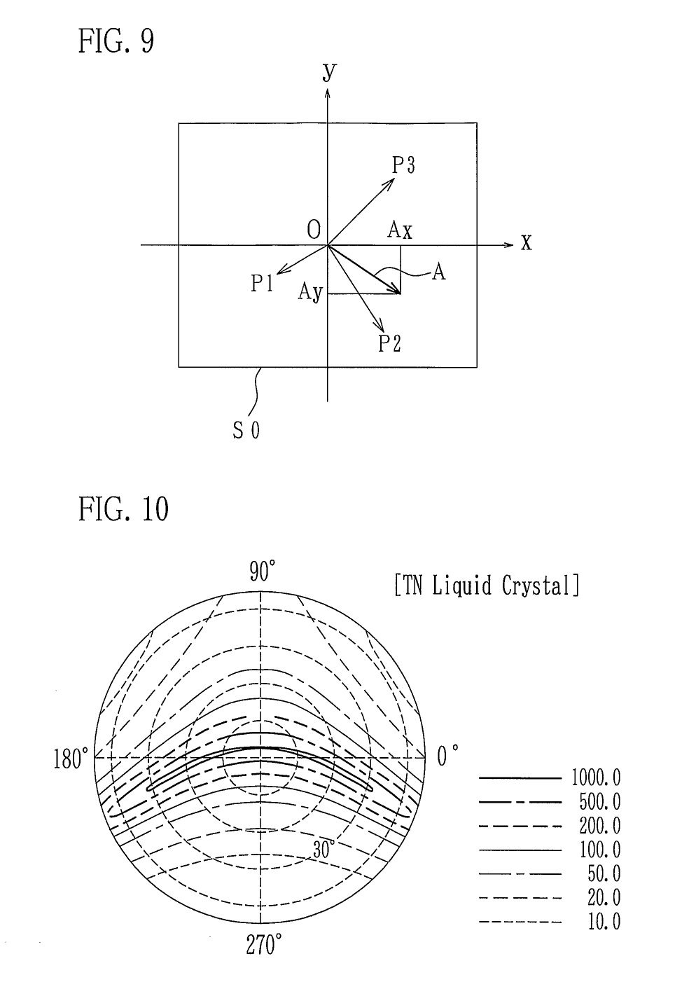

More specifically, the synthetic vector A is determined such that a condition formula 1 about the x and y coordinate value (Ax, Ay) of the synthetic vector A is satisfied, when the optical axis vectors P1 to P3 of the oblique deposition films S1 to S3 are synthesized and the synthetic vector A is orthogonally projected on the deposition surface SO as shown in FIG. 9 in which x-y surface is seen from the positive direction of Z-axis in FIG. 6. The condition formula 1 is as follows:
−200 nm≦Ax≦200 nm and
−500 nm≦Ay≦0 nm (Condition formula 1-I)

Ax and Ay are defined by same coordinate system as the XYZ coordinate system described in FIGS. 6 and 7, and determined corresponding to the direction of the long axis of the liquid crystal molecules distributed in center area in thickness direction of the liquid crystal cell. Ax and Ay are not relevant to the twist direction of the liquid crystal molecules. More preferable values of Ax, Ay are as follows:
−100 nm≦Ax≦100 nm and
−300 nm≦Ay≦−50 nm (Condition formula 1-II)

In the TN liquid crystal element 2, the ratio of the liquid crystal molecules 38 which become the vertical orientation is varied according to the value of the saturation voltage applied for dark state display. Since the first phase difference compensating layer 12 is for compensating optical anisotropy by the birefringence effect of the liquid crystal molecules 38 in the vertical orientation, the value of the retardation of the first phase difference compensating layer 12 becomes larger when the rate of the liquid crystal molecules 38 in the vertical orientation is larger. The retardation of the liquid crystal molecules 38 in the vertical orientation is in a range of 50% to 90% of that of the whole TN liquid crystal cell.

To determine the retardation of the first phase difference compensating layer 12, another factor needs to be considered. That is, there is a need to cancel excess compensation of the phase difference in the positive Z-axial direction caused by the second phase difference compensating layer 14. The oblique deposition layers S1 to S3 compensate angle dependence of the phase difference by the liquid crystal molecules near the substrates of the TN liquid crystal element 2. However, to compensate the phase difference by the liquid crystal molecules in approximately parallel to the substrate, an oblique deposition film whose optical axis is approximately parallel to the substrate, that is, the polar angle β is approximately 90° so that the direction of the columnar element is approximately parallel to the substrate, is needed. To produce such oblique deposition film is extremely difficult in reality.

Accordingly, to compensate the phase difference by the liquid crystal molecules in approximately parallel to the substrate, a thick oblique deposition film having smaller polar angle than a theoretical angle is need to be used. As a result, in the perpendicular direction to the substrate, the excess compensation of the phase difference is performed. For this reason, the first phase difference compensating layer 12 needs to have an effect for reducing the excess compensation by the second phase difference compensating layer 14. The amount of the retardation of the first phase difference compensating layer 12 is determined to generate a negative phase difference for canceling the excess positive phase difference occurred by the compensation performance of the second phase difference compensating layer 14.

Although the lower limit of the amount of the retardation is “0”, the upper limit thereof is dependent on the amount of the excess positive phase difference. In practical, the film thickness is limited by conditions such as difficulty and cost of forming the film.

In consideration of above factors, preferable relation between the negative retardation (dΔn) of the first phase difference compensating layer 12 and the positive retardation (dΔn)_{LC} of the TN liquid crystal element is as follows:
−2×(dΔn)_{LC}≦(dΔn)≦−0.5×(dΔn)_{LC} (Condition formula 2)

As the deposition material of the second phase difference compensating layer 14, as same as the deposition material of the first phase difference compensating layer 12, materials having sufficient optical transparency independent of wavelength in form of the oblique deposition film, such as TiO₂, SiO₂, ZrO₂ and Ta₂O₃, can be used.

Hereinafter, concrete experiments of the phase difference compensator 6 of the present invention are explained. These experiments is for evaluating the optimum structural conditions of the first and second phase difference compensating layer suitable for the TN liquid crystal element, based on a contrast ratio curve. The TN liquid crystal element is in conditions that the birefringence (Δn) in the wavelength of 550 nm is 0.124, the thickness of the cell (the thickness of the liquid crystal layer) is 4500 nm, and the value of the retardation (dΔn)_{LC} is 558 nm. The contrast ratio curve is formed such that a brightness ratio between the light state and the dark state of the liquid crystal is measured as the contrast ratio at each view angle, and the view angles having same contract ratio are connected. The contrast ratio curve of the TN liquid crystal element itself is shown in FIG. 10. As seen from FIG. 10, the contrast is largely varied according to the view angle. Note that in the experiments described below, the film forming is performed in a condition that the reference wavelength of the first and second phase difference compensating layer is 550 nm.

(Experiment 1)

Corning 1737 (50 mm×50 mm) as the glass substrate was washed by acetone and sufficiently dried, and then set in a deposition device for performing normal front deposition (β=0°). A vacuum chamber discharged the air to be 1×10⁻⁴ Pa, and the glass substrate was heated at 300° C. to form a three-layer anti-reflection film. The anti-reflection film was a stacked SiO₂ of λ/4 optical thickness, TiO₂ of λ/2 optical thickness, and SiO₂ of λ/4 optical thickness in this order from the side of the glass substrate. The reference wavelength λ was 550 nm.

After forming the anti-reflection layer, the glass substrate was turned inside out in the vacuum chamber, to form the first phase difference compensating layer. The first phase difference compensating layer comprised multilayer film in which two kinds of deposition films L1, L2 were alternately stacked as shown in FIG. 3. The retardation (dΔn) thereof was negative. Since the retardation (dΔn) can be controlled some degree by changing the total physical film thickness d and the birefringence An, the retardation value of the first phase difference compensating layer was set at −600 nm.

Supplementary explanation of the first phase difference compensating layer is as follows. It is known that a lamination, including thin films respectively having refractive index n₁, n₂ and physical film thickness a, b which are alternately stacked in a pitch (a+b) substantially shorter than the wavelength, becomes a form birefringence body having negative birefringence An. When electromagnetic wave is perpendicularly entered into the form birefringence body, there is only TE wave in which an electric field vibrates in parallel with a plane of each layer. Therefore, the form birefringence body does not show the birefringence property. However, when the electromagnetic wave is obliquely entered into each lamination surface of plural layers, there are TE wave component in which an electric field vibrates in parallel with a plane of each layer and TM wave component in which an electric field vibrates perpendicular to a plane of each layer, whose effective refractive indexes N_{TE}, N_{TM} are different. The effective refractive indexes N_{TE}, N_{TM} are shown as follows:
N_{TE}={(an₁²+bn₂²)/(a+b)}^{(1/2)}
N_{TM}=[(a+b)/{(a/n₁²)+(b/n₂²)}]^{(1/2)}
The difference between these effective refractive indexes N_{TE} and N_{TM} is the factor to occur the birefringence property, and the birefringence Δn is calculated by a formula:
Δn=N_{TM}−N_{TE}
The above formulae show that the birefringence Δn can be determined by selecting the refractive index n₁, n₂ of the deposition layers L1, L2 and whose physical film thickness a and b. Further, the total physical film thickness d can be determined by change a lamination number of the deposition layers L1, L2. Accordingly, by selecting a deposition material having optical transparency and superior deposition suitability and designing the film, the value of the retardation (dΔn) of the first phase difference compensating layer can be close to the value of the retardation (dΔn)_{LC} of the TN liquid crystal element.

The glass substrate, on which the first phase difference compensating layer is formed as described above, was taken out from the vacuum chamber. The glass substrate was cleansed again by acetone and sufficiently dried, and then set in the deposition device shown in FIG. 5. The deposition of the second phase difference compensating layer having two films was performed such that the deposition surface was the uppermost film of the first phase difference compensating layer. The first film was the oblique deposition film S1 in which the azimuth α was −137°, the polar angle β was 45° and the retardation (dΔn)_{S1} was 150 nm. And the second film was the oblique deposition film S2 in which the azimuth α was −45°, the polar angle β was 33° and the retardation (dΔn)_{S2} was 180 nm. After forming the second phase difference compensating layer with monitoring the measuring data from the ellipsometer 32 and the film thickness monitor 31, the sample was taken off from the deposition device shown in FIG. 5 and set in the deposition-device for performing normal front deposition, to form a three-layer anti-reflection film same as the three-layer anti-reflection film formed at first.

As the deposition material for the oblique deposition films S1 and S2 of the second phase difference compensating layer, ZrO₂ mixed with 10 weight percent of TiO₂ was used. For forming the film, the vacuum chamber was applied the vacuum process until 1×10⁻⁴ Pa, then oxygen gas was putted into the vacuum chamber until 1×10⁻² Pa, to sufficiently oxygenize the film. In experiment 1 as described above, constructions and parameters of the obtained first and second phase difference compensating layers are shown in Table 1.

TABLE 1

| | | azimuth | polar | (dΔn) |
|---|---|---|---|---|
| Experiment 1 | | α° | angle β° | (nm) |
| second phase | S2 | −45 | 33 | 180 |
| difference | S1 | −137 | 45 | 150 |
| compensating | | | | |
| layer | | | | |
| first phase | | | | −600 |
| difference | | | | |
| compensating | | | | |
| layer | | | | |
| glass | | | | |
| substrate | | | | |

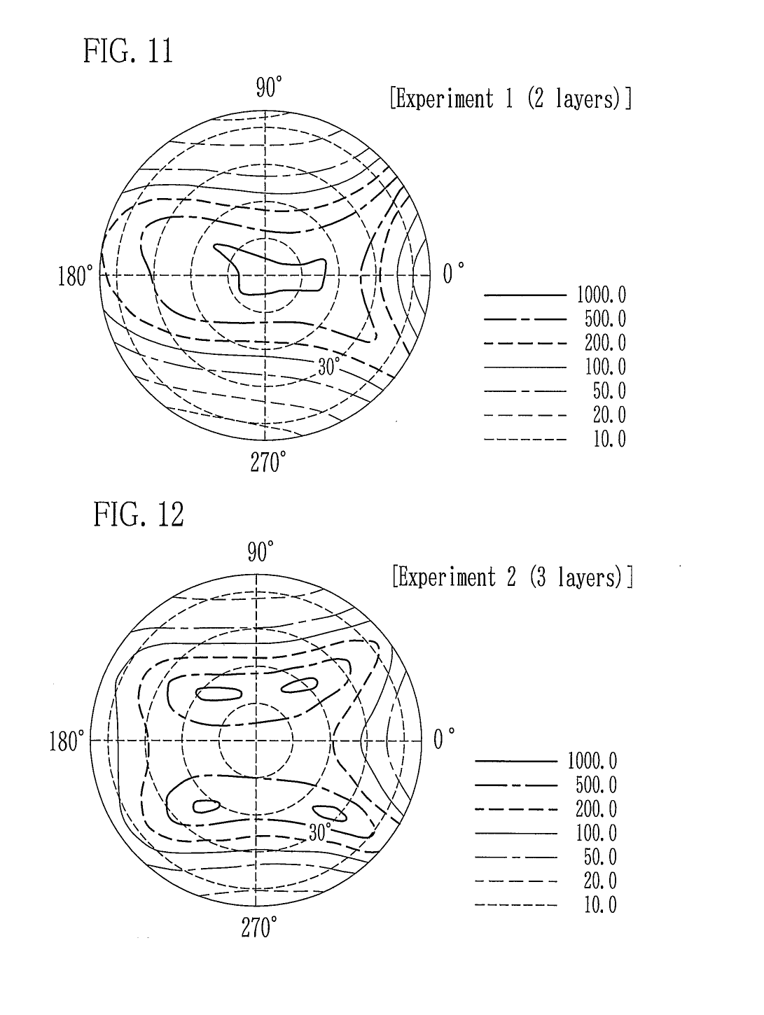

When the phase difference compensator of Experiment 1 was applied to the TN liquid crystal element, the contrast ratio curve became a state shown in FIG. 11. It was clear that the view angle property of the contrast ratio curve in FIG. 11 was improved from that in FIG. 10 which shows the contrast ratio curve of the TN liquid crystal element itself.

Since the X and Y coordinate value was (83, −83) when the optical axis vector P1 of the oblique deposition film S1 was orthogonally projected on the deposition surface, and that was (−110, −102) when the optical axis vector P2 of the oblique deposition film S2 was orthogonally projected on the deposition surface, the X and Y coordinate value of the synthetic vector A of the optical axis vectors P1, P2 became (−27, −183). Accordingly, the condition formula 1 was satisfied. In addition, since the retardation (dΔn) of the first phase difference compensating layer was −600 nm, which is in a range from a minimum value −1118 nm to a maximum value −279 nm of the condition formula 2 when the retardation of the TN liquid crystal element was 558 nm, the condition formula 2 was also satisfied.

(Experiment 2)

As same as Experiment 1, a sample of Experiment 2 was formed. The constructions of the TN liquid crystal element and the anti-reflection layer were same as Experiment 1, and the film constructions of the first and second phase difference compensating layers were different from Experiment 1. Constructions and parameters of the first and second phase difference compensating layers are shown in Table 2. In Experiment 2, the second phase difference compensating layer has three films, and the azimuth α of each film is rotated in a same direction. Accordingly, the optical axis vectors P1 to P3 are rotated sequentially in counterclockwise direction in a spiral manner on the deposition surface.

TABLE 2

| | | azimuth | polar | (dΔn) |
|---|---|---|---|---|
| Experiment 2 | | α° | angle β° | (nm) |
| second phase | S3 | −15 | 44 | 70 |
| difference | S2 | −41 | 27 | 80 |
| compensating | S1 | −127 | 45 | 190 |
| layer | | | | |
| first phase | | | | −370 |
| difference | | | | |
| compensating | | | | |
| layer | | | | |
| glass | | | | |
| substrate | | | | |

The contrast ratio curve of Experiment 2 is shown in FIG. 12. A high contract region became larger than that of Experiment 1, and the dependency on the view angle became lower than that of Experiment 1. The x and y coordinate value of the synthetic vector A of the optical axis vectors P1 to P3 of the oblique deposition films S1 to S3 became (−18, −196). Since the retardation of the first phase difference compensating layer was −370 nm, both the condition formula 1, and the condition formula 2 were satisfied.

(Experiment 3)

In Experiment 3, the retardation of the first phase difference compensating layer was −440 nm, and the second phase difference compensating layer has three layers as same as Experiment 2. Constructions and parameters of the first and second phase difference compensating layers are shown in Table 3. In Experiment 3, the azimuth α of the third layer of the second phase difference compensating layer is rotated in a direction counter to the rotational direction of the azimuth α in each of the first and second layer, in contrast with Experiment 2, in which the optical axis vectors P1 to P3 are rotated sequentially in one direction in the spiral manner.

TABLE 3

| | | azimuth | polar | (dΔn) |
|---|---|---|---|---|
| Experiment 3 | | α° | angle β° | (nm) |
| second phase | S3 | −44 | 42 | 110 |
| difference | S2 | −22 | 44 | 50 |
| compensating | S1 | −131 | 45 | 180 |
| layer | | | | |
| first phase | | | | −440 |
| difference | | | | |
| compensating | | | | |
| layer | | | | |
| glass | | | | |
| substrate | | | | |

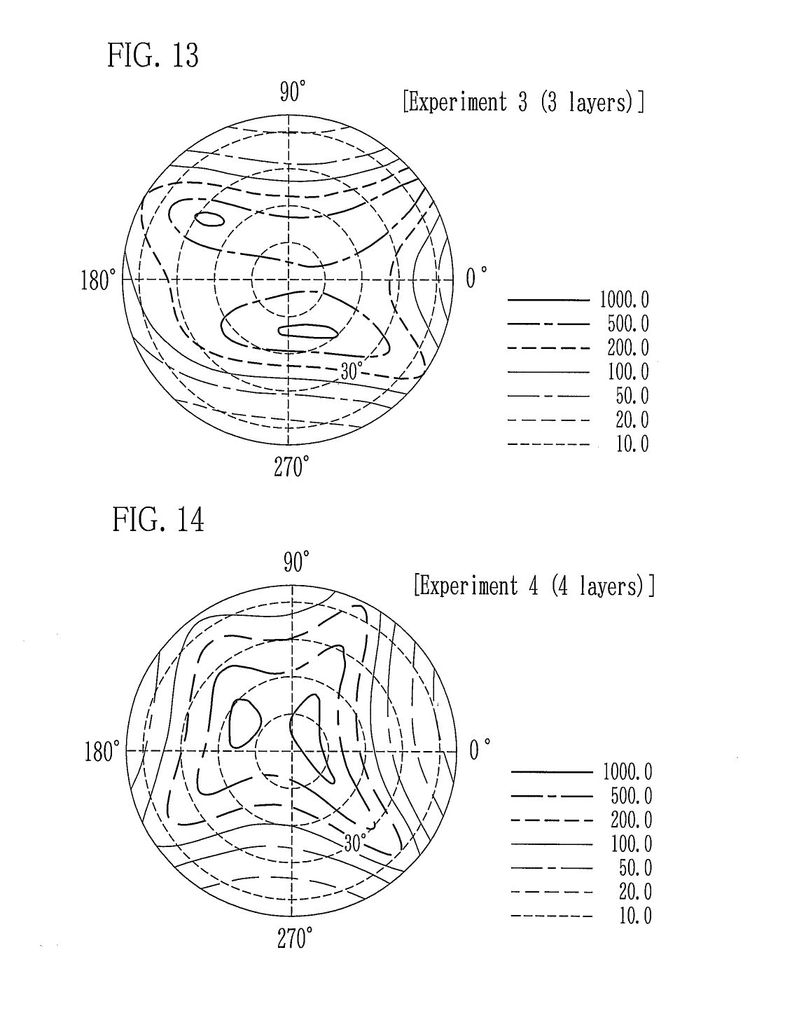

The contrast ratio curve of Experiment 3 is shown in FIG. 13. The view angle property is kept well. The X and Y coordinate value of the synthetic vector A of the optical axis vectors P1 to P3 of the oblique deposition films S1 to S3 became (−2, −223). Since the retardation of the first phase difference compensating layer was −440 nm, both the condition formula 1, and the condition formula 2 were satisfied. Note that despite the three optical axis vectors of the three films in the second phase difference compensating layer were not rotated in the spiral manner, there was few influence to the view angle property although the shape of the contrast ratio curve was changed, as seen from a comparison between FIGS. 12 and 13.

(Experiment 4)

In Experiment 4, the retardation of the first phase difference compensating layer is −500 nm, and the second phase difference compensating layer has four films. Constructions and parameters of the first and second phase difference compensating layers are shown in Table 4. The oblique deposition films S1 to S4 of the second phase difference compensating layer are determined such that the azimuth α of each film is rotated in a same direction. Accordingly, the optical axis vectors P1 to P4 are rotated sequentially in counterclockwise direction in a spiral manner.

TABLE 4

| | | azimuth | polar | (dΔn) |
|---|---|---|---|---|
| Experiment 4 | | α° | angle β° | (nm) |
| second phase | S4 | −138 | 40 | 104 |
| difference | S3 | −116 | 24 | 214 |
| compensating | S2 | −16 | 24 | 72 |
| layer | S1 | 22 | 24 | 104 |
| first phase | | | | −500 |
| difference | | | | |
| compensating | | | | |
| layer | | | | |
| glass | | | | |
| substrate | | | | |

The contrast ratio curve of Experiment 4 is shown in FIG. 14. The view angle property is improved. The X and Y coordinate value of the synthetic vector A of the optical axis vectors P1 to P4 of the oblique deposition films S1 to S4 became (32, −77). Since the retardation of the first phase difference compensating layer was −500 nm, both the condition formula 1, and the condition formula 2 were satisfied.

(Experiment 5)

In Experiment 5, the retardation of the first phase difference compensating layer is −470 nm, and the second phase difference compensating layer has four films. Constructions and parameters of the first and second phase difference compensating layers are shown in Table 5. The azimuth α of each of the oblique deposition films S1 to S4 in the second phase difference compensating layer is rotated in a direction counter to that in Experiment 4. Accordingly, the optical axis vectors P1 to P4 are rotated sequentially in clockwise direction in a spiral manner.

TABLE 5

| | | azimuth | polar | (dΔn) |
|---|---|---|---|---|
| Experiment 5 | | α° | angle β° | (nm) |
| second phase | S4 | 5 | 40 | 106 |
| difference | S3 | −40 | 45 | 40 |
| compensating | S2 | −117 | 44 | 120 |
| layer | S1 | −130 | 35 | 130 |
| first phase | | | | −470 |
| difference | | | | |
| compensating | | | | |
| layer | | | | |
| glass | | | | |
| substrate | | | | |

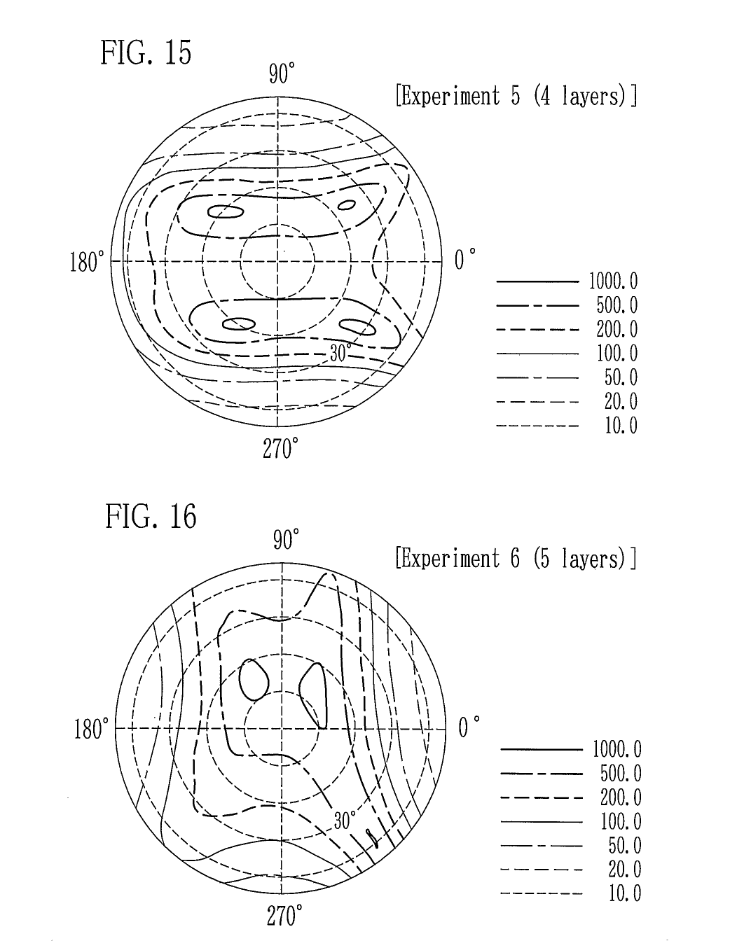

The contrast ratio curve of Experiment 5 is shown in FIG. 15. The favorable view angle property was obtained. The X and Y coordinate value of the synthetic vector A of the optical axis vectors P1 to P4 of the oblique deposition films S1 to S4 became (8, −191). Since the retardation of the first phase difference compensating layer was −470 nm, both the condition formula 1, and the condition formula 2 were satisfied. It was found that the favorable view angle property can be obtained both when the spiral direction of the optical axis vectors of the films in the second phase difference compensating layer is determined as Example 4 and when that is determined as Example 5. However, it does not mean that the spiral direction of the optical axis vector does not affect the view angle property. When the spiral direction was changed, the optimum value of the combination, including the azimuth α and polar angle β of the each film, the retardation of each film of the second phase difference compensating layer and the retardation of the first phase difference compensating layer, was changed.

(Experiment 6)

In Experiment 6, the retardation of the first phase difference compensating layer is −350 nm, and the second phase difference compensating layer has five films. Constructions and parameters of the first and second phase difference compensating layers are shown in Table 6. The optical axis vectors P1 to P5 of the oblique deposition films S1 to S5 are rotated in the spiral manner.

TABLE 6

| | | azimuth | polar | (dΔn) |
|---|---|---|---|---|
| Experiment 6 | | α° | angle β° | (nm) |
| second phase | S5 | −130 | 45 | 200 |
| difference | S4 | −116 | 43 | 80 |
| compensating | S3 | −46 | 45 | 70 |
| layer | S2 | −10 | 45 | 50 |
| | S1 | 30 | 45 | 80 |
| first phase | | | | −350 |
| difference | | | | |
| compensating | | | | |
| layer | | | | |
| glass | | | | |
| substrate | | | | |

The contrast ratio curve of Experiment 6 is shown in FIG. 16. The favorable view angle property was obtained. The X and Y coordinate value of the synthetic vector A of the optical axis vectors P1 to P5 of the oblique deposition films S1 to S5 became (6, −239). Since the retardation of the first phase difference compensating layer was −350 nm, both the condition formula 1, and the condition formula 2 were satisfied.

As described in Experiments 1 to 6, the combination of the retardation of the first phase difference compensating layer and the proper construction of the second phase difference compensating layer having plural films can effectively compensate the dependency on the view angle in the TN liquid crystal element. Especially, the proper film configuration of the second phase difference compensating layer is affected by the retardation of the first phase difference compensating layer, which means that there are huge amount of the combinations of parameters to obtain the optimum view angle property. However, above examinations shows that the combination of the first and second phase difference compensating layers needs to satisfy at least the condition formulae 1 and 2.

Basically, the retardation value of the first phase difference compensating layer needs to determine according to the positive birefringence of the liquid crystal molecules and the thickness of the liquid crystal layer. However, in some kinds of the TN liquid crystal element, the ratio of the liquid crystal molecules, which become the vertical orientation when the voltage is applied, is not constant. Accordingly, the retardation value of the first phase difference compensating layer should be determined with consideration of range of fluctuation of the ratio. In addition, the retardation value should be adjusted according to the positive birefringence of the second phase difference compensating layer.

In addition, as stated above, the position of the phase difference compensator of the present invention is not limited at the light exit surface side of the TN liquid crystal element, and can be at the light incident surface side thereof. Also, the first phase difference compensating layer and the second phase difference compensating layer can be formed on respective glass substrates and used with keeping a distance between them. Further, it is one of preferable embodiments that at least one of the base plates of the one pair of polarizing plates, which is disposed respectively at the light incident surface side and the light exit side of the TN liquid crystal element, is used as a base of the first phase difference compensating layer and/or the second phase difference compensating layer.

The phase difference compensator of the present invention can be applied to a full-color direct view type liquid crystal display having a single-panel of the TN liquid crystal element as a display element, when the reference wavelength is set at for example 550 nm for forming the first and second phase difference compensating layers. However, since the birefringence effect of each of the liquid crystal molecules and the phase difference compensator is varied according to the wavelength, it is preferable that the specific constructions of the films in the phase difference compensators are provided corresponding to a reference wavelength of each of component color lights. In this type of the liquid crystal display, micro color filters, which respectively transmit one of red, green and blue color lights as the component color lights, are incorporated in the TN liquid crystal element in general. Accordingly, it is preferable that the three types of the phase difference compensators having different film constructions corresponding to the each color filter are used.

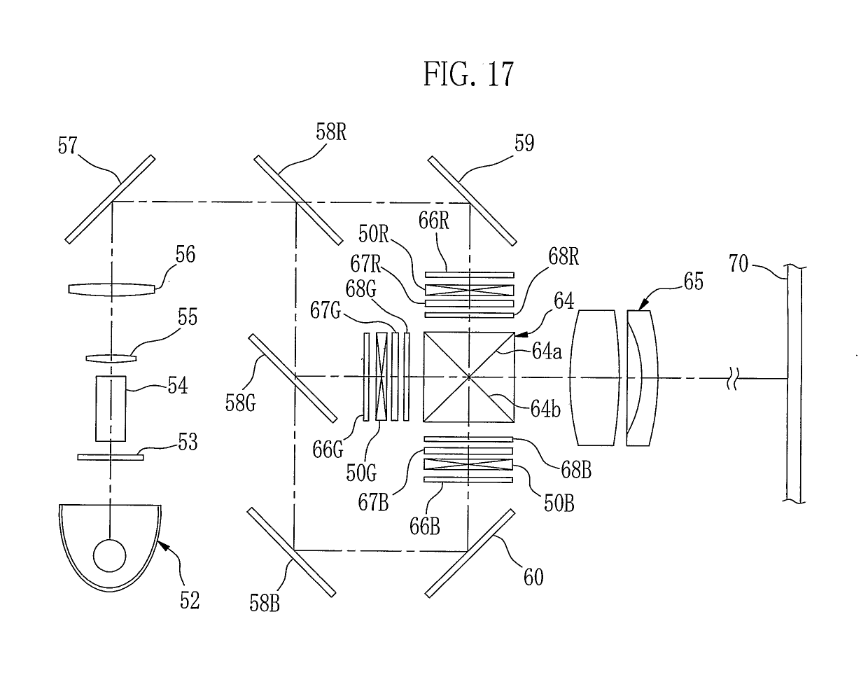

To change the film construction of the phase difference compensator according to the reference wavelength of the each component color light is effectively applied to a three-panel type liquid crystal projector including three TN liquid crystal element elements corresponding to each component color light. The construction of the three-panel type liquid crystal projector is schematically shown in FIG. 17.

In FIG. 17, three liquid crystal elements 50R, 50G, 50B respectively display monochrome image having a transmission density according to an image of each component color, which are red, green and blue. Emission light from a light source 52 becomes white light including red, green and blue light by a cut filter 53 to cut ultraviolet and infrared components. White light goes along an illumination light axis (one dotted line in the drawing) and enters a glass rod 54 as an integrator. Since the incident plane of the glass rod 54 is located in the vicinity of the focal position of the parabolic reflector of the light source 52, white light from the cut filter 53 enters the incident plane of the glass rod 14 without having large loss.

After passing through the glass rod 54, white light is collimated by a relay lens 55 and a collimate lens 56. Collimated white light is reflected on a mirror 57 toward a dichroic mirror 58R that passes red light and reflects blue and green light. The liquid crystal element for red image 50R is illuminated from behind by red light that is reflected on a mirror 59. Blue and green light, reflected on the dichroic mirror 58R, reaches a dichroic mirror 58G in which only green light is reflected. Green light reflected on the dichroic mirror 58G illuminates the liquid crystal element for green image 50G from behind. Blue light, reflected on mirrors 58B, 60, illuminates the liquid crystal element for blue image 50B from behind.

The liquid crystal elements 50R, 50G, 50B contain the TN liquid crystal element layer and displays red, green and blue density images, respectively. A color recombining prism 64 is located at the position where the optical distances from the center of the color recombining prism 64 to the liquid crystal elements 50R, 50G, 50B are the same. The color recombining prism 64 has two dichroic planes 64a, 64b to reflect red light and blue image light respectively, so that red, green and blue image light is mixed into full color image light. A projection lens system 65 is located on a projection optical axis from the exit plane of the color recombining prism 64 to a screen 70. The object side focal point of the projection lens system 65 is on the exit planes of the liquid crystal elements 50R, 50G, 50B. The image side focal point of the projection lens system 65 is on the screen 70. Thus, full color image light from the color recombining prism 64 is focused on the screen 70 by the projection lens system 65.

Front polarizing plates 66R, 66G, 66B as the polarizers are respectively provided in front of the incident planes of the liquid crystal elements 50R, 50G, 50B. Phase difference compensators 67R, 67G, 67B and rear polarizing plates 68R, 68G, 68B as the analyzers are arranged in the exit plane side of the liquid crystal elements 50R, 50G, 50B. The polarization direction of the front polarizing plates 66R, 66G, 66B and the rear polarizing plates 68R, 68G, 68B are perpendicular to each other (cross nicol configuration). Each of the phase difference compensators 67R, 67G, 67B includes the first phase difference compensating layer and the second phase difference compensating layer, for respectively compensating the phase difference of each color of the liquid crystal elements 50R, 50G, 50B, as described above.

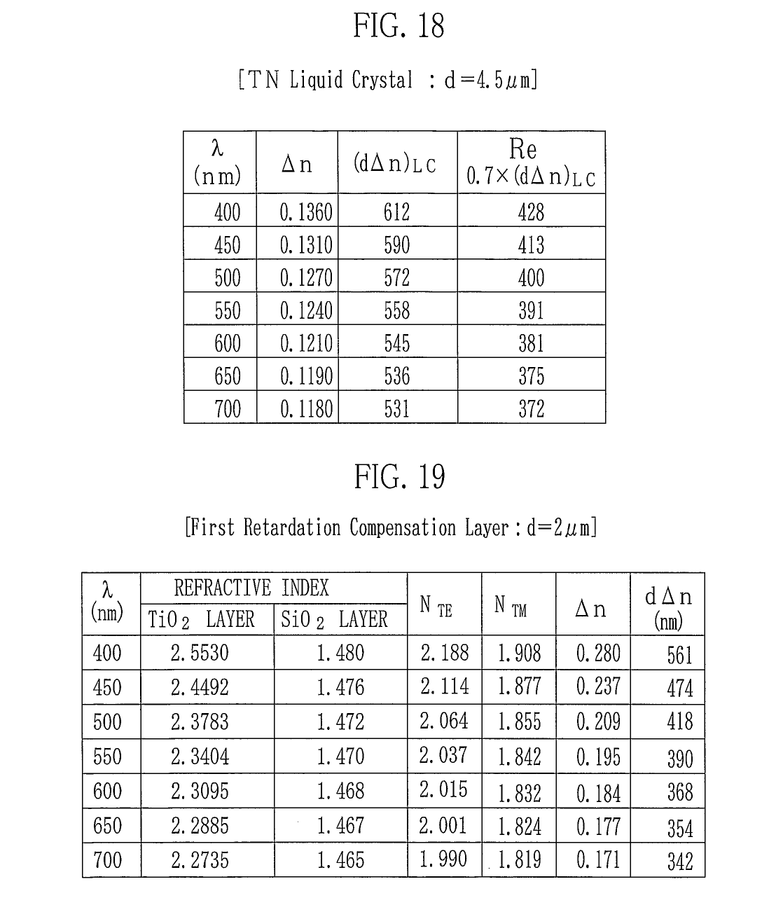

Although the liquid crystal elements 50R, 50G, 50B have the same TN liquid crystal element, it is known that the retardation (dΔn)_{LC} is varied according to the wavelength in general. FIG. 18 shows the wavelength dependence of the TN liquid crystal element whose thickness is 4.5 μm. The birefringence Δn is varied according to the wavelength, and the retardation (dΔn)_{LC} is also varied according to that. In the figure, Re means an effective retardation when the ratio of the liquid crystal molecules, which become the vertical orientation according to the application of the voltage, is 70%. The above-described first phase difference compensating layer is for compensating the positive phase difference by the effective retardation Re. Note that the rate of the liquid crystal molecules in the vertical orientation is not limited to 70%, and it is varied by factors such as the construction, the thickness, density and the saturation voltage value of the TN liquid crystal element.

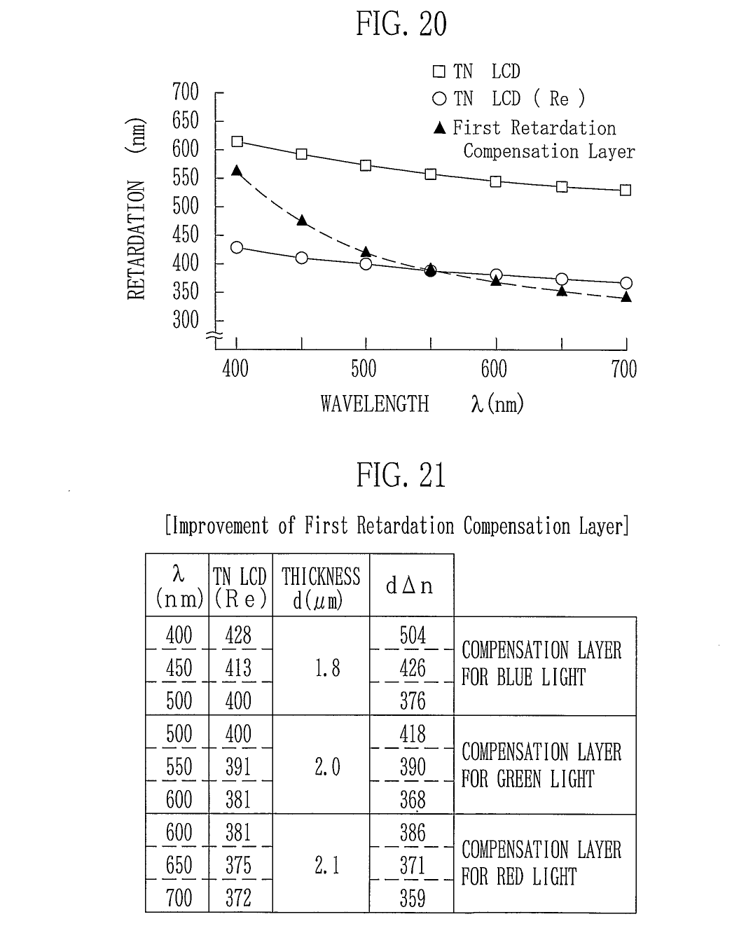

In order to effectively compensate the effective retardation Re of the TN liquid crystal element, the first phase difference compensating layer is composed of 40 TiO₂ film each of which has 30 nm thickness and 40 SiO₂ film each of which has 20 nm thickness that are alternately stacked on a substrate. As shown in FIG. 19, absolute value of the negative retardation (dΔn) of the first phase difference compensating layer is dependent on the wavelength, because the refractive indexes of the TiO₂ film and the SiO₂ film have wavelength dependence. The first phase difference compensating layer is designed to effectively compensate the phase difference at 550 nm wavelength having high visibility in visible region. However, as shown in FIG. 20, in shorter wavelength side, it cannot perform the proper compensation of the phase difference.

In consideration of the above problem, in the present invention, the thickness of the first phase difference compensating layer of the each phase difference compensator 67R, 67G, 67B is changed according to each color channel, by use of the feature of, the first phase difference compensating layer comprising the deposition film whose thickness is sufficiently shorter than the wavelength. That is, the negative birefringence An is determined by the refractive indexes and the ratio of the thickness of the two kinds of deposition films, and the retardation value can be controlled by changing the total film thickness (number of stacked the each layer) by which the birefringence An is multiplied. One example is shown in FIG. 21.

In this example, the thickness of the first phase difference compensating layer is changed respectively for blue, green and red light. The physical thicknesses of the TiO₂ film and the SiO₂ film in the deposition film are 30 nm and 20 nm in all color channels. However, according to 413 nm of the retardation of the TN liquid crystal element when the reference wavelength λ is 450 nm, which is approximately center wavelength of the blue component light, the first phase difference compensating layer for blue light has 72 stacked films and 1.8 μm of the total film thickness d. In the same manner, when the reference wavelength λ is 550 nm for the green component light, the first phase difference compensating layer for the green light has 80 stacked films and 2.0 μm of the total film thickness d. And when the reference wavelength λ is 650 nm for the red component light, the first phase difference compensating layer for the red light has 82 stacked films and 2.1 μm of the total film thickness d.

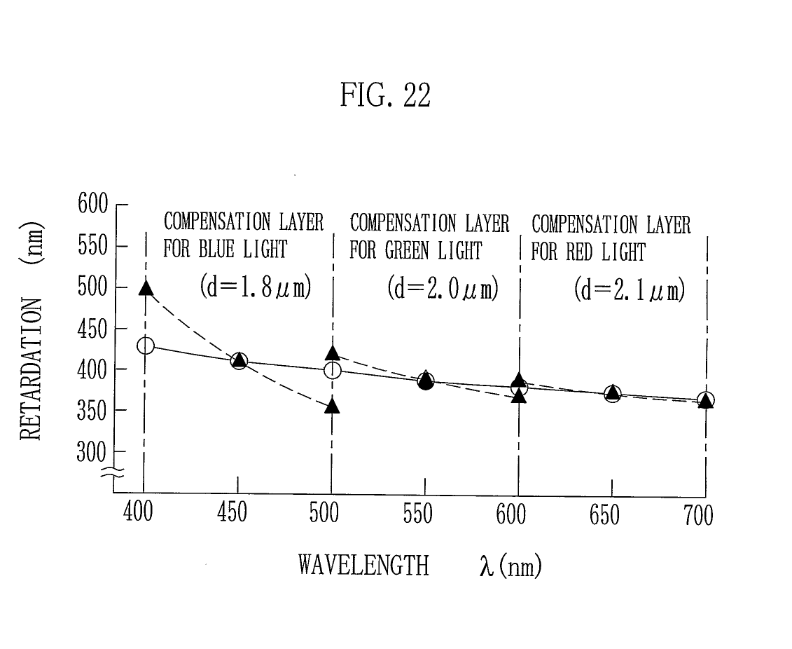

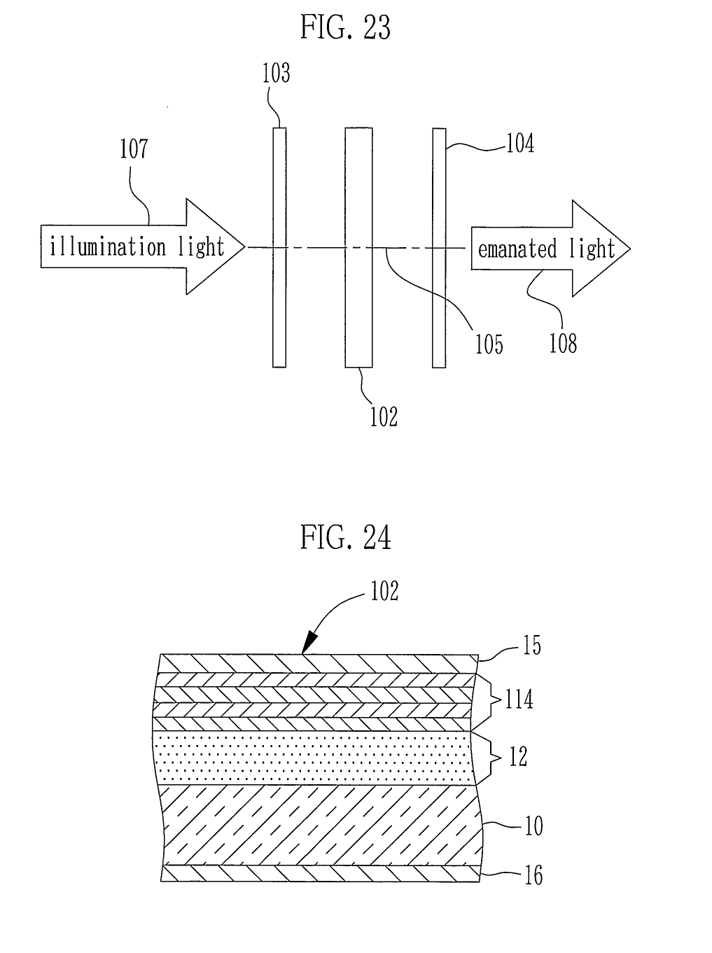

As a result, as shown in FIG. 22, it is proved that the retardation of the each color channel of liquid crystal element 50R, 50G, 50B can be compensated well according to respective wavelength of the each color light. In case that the solid-blue background is projected on the screen 70, the whole area of the liquid crystal element 50B is in the light state, and the whole areas of the liquid crystal element 50R, 50G are in the dark state. At this time, the positive phase difference, which is from the birefringence effect of the liquid crystal molecules oriented vertically in the liquid crystal elements 50R, 50G by application of the saturation voltage, is effectively compensated by the negative retardation, which is from the first phase difference compensating layers for the red light and the green light respectively provided in the phase difference compensators 67R and 67G. Accordingly, it is hardly generated the emanated light from the polarizing plates 68R and 68G as the analyzers, which enables the projection of the vivid solid-blue background without blurring.

By the same reason, the contrast ratio, between when the white light is projected on whole area of the screen and when the whole area of the screen is in dark state, is improved from 500:1 to 700:1. In addition, for projecting the general full-color image, the sharpness of the image is improved by the tighten black. Note that as seen from FIG. 22, the wavelength dependence of the first phase difference compensating layers for the green and red lights are lower than that for the blue light. Accordingly, it is possible that the first phase difference compensating layers having same total film thickness are respectively used for the green and red lights. In this case, it is preferable that the total film thickness is determined with reference to 600 nm wavelength.

As described above, when the phase difference compensator of the present invention is applied to the three-panel type of color liquid crystal projector, it is effective that the total film thickness of the first phase difference compensating layer is adjusted at least for every two of the color channels. The above explanations considers only the wavelength dependence of the retardation (dΔn)_{LC} of the liquid crystal elements 50R, 50G, 50B. However, the second phase difference compensating layer in each of the phase difference compensators 67R, 67G, 67B also has the reference wavelength different in each color channel, and has the specific construction corresponding to the each reference wavelength. The second phase difference compensating layer has the positive retardation as same as the liquid crystal molecules. Accordingly, it is preferable that the total film thickness of the first phase difference compensating layer is increased for an adjustment. Note that even if the adjustment is performed, the negative retardation of the first phase difference compensating layer of each color channel can be satisfy the condition formula 2.

It is possible that the above-mentioned phase difference compensators 67R, 67G, 67B are positioned respectively in the light incident surface side of each of the liquid crystal elements 50R, 50G, 50B. In addition, there is a case that a micro lens array including plural micro lenses, each of which corresponds to each pixel for improving aperture efficiency, is used in the liquid crystal element. In this type of the liquid crystal element, generally incident angle distribution of the illumination light entering to the liquid crystal layer is wider than that of the illumination light entering to the micro lens array. Accordingly, to effectively compensate the phase difference, it is preferable that the phase difference compensators 67R, 67G, 67B are positioned respectively in the light exit surface side of each of the liquid crystal elements 50R, 50G, 50B.

It is expected that the contrast ratio on the screen 70 becomes 1000:1 or more, by using the phase difference compensators 67R, 67G, 67B in which the first and second phase difference compensating layers are optimized as described above. In addition, since the phase difference compensator is formed of only the inorganic material, there is no problem of heat resistance or light resistance. Accordingly, the phase difference compensator of the present invention can be effectively applied to products such as a rear-projection television for home use, which are used in long period of time.

Heretofore, the phase difference compensator and the liquid crystal projector of the first embodiment of the present invention are described. As the substrate for forming the phase difference compensator, some transparent inorganic materials can be used as same as the glass substrate. The preferable materials are a sapphire substrate and a quartz substrate which have high heat conductance, to apply to the liquid crystal projector. In addition, it is possible that the first phase difference compensating layer and the second phase difference compensating layer are formed respectively on individual transparent substrates. And lenses, prisms, some kind of filters, and substrates of the liquid crystal elements which are in the optical system can be used as the transparent substrates for the phase difference compensating layers.

Next, a phase difference compensator of a second embodiment of the present invention will be described. Note that components in the second embodiment, which are also used in the first embodiment, are applied the same numerals as in the first embodiment, and detail explanation of these components are omitted. As shown in FIG. 23, the phase difference compensator 102 is disposed between the polarizing plates 103, 104, and these members 102-104 are directed in vertical to an optical axis 105. The polarizing plates 103, 104 are in the cross nicol configuration, in which transmission axes of the polarizing plates 103, 104 are at right angles to each other. When an illumination light 107 includes only light beams parallel to the optical axis 105, the light is not emanated from the polarizing plate 104 in a light exit side even if there is not the phase difference compensator 102. However, when the illumination light 107 includes a light beam not parallel to the optical axis 105, the light is emanated from the polarizing plate 104 if there is not the phase difference compensator 102. By use of the phase difference compensator 102, the emanated light 108 from the polarizing plate 104 can be largely reduced even when the illumination light includes light slant to the optical axis 105.

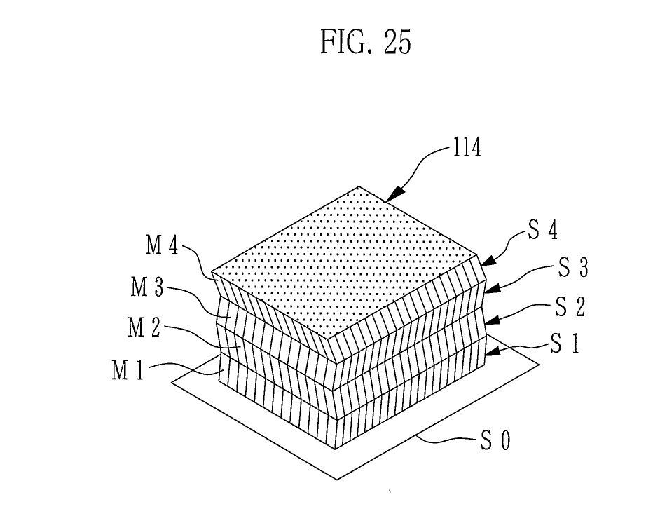

As shown in FIG. 24, the phase difference compensator 102 has a construction basically same as that of the phase difference compensator 6 shown in FIG. 2. But as shown in FIG. 25, a second phase difference compensating layer 114 includes four kinds of oblique deposition films S1 to S4. In this embodiment, the first oblique deposition film S1 is stacked on the first phase difference compensating layer 12. However, it is possible that the positions of the first and second phase difference compensating layers 12 and 114 are interchanged, such that the first oblique deposition film S1 is formed on the glass substrate 10, the second to fourth oblique deposition films S2 to S4 are sequentially formed on the first oblique deposition film S1, and then the first phase difference compensating layer 12 is formed on the fourth oblique deposition film S4. In addition, it is also possible that the first phase difference compensating layer 12 and the second phase difference compensating layer 114 are respectively formed on both sides of the glass substrate 10, and the anti-reflection layers 15 and 16 are respectively formed on outermost layers of the first and second phase difference compensating layers 12, 114.

Different from the deposition films L1 and L2 of the first phase difference compensating layer 12, the oblique deposition films S1 to S4 of the second phase difference compensating layer 114 are deposited from oblique direction toward a deposition surface S0. Each of the deposition films Si to S4 respectively has microscopic columnar elements M1 to M4 which are obliquely extended toward whose deposition direction. Each of oblique deposition films S1 to S4 as single layer can show form birefringence effect and can be used as O-plate having positive birefringence. However, the oblique deposition films S1 to S4 shows optical isotropy to a light parallel to the direction of the columnar elements M1 to M4. Accordingly, the optical axis is entered in the films S1 to S4 with refraction at the interface between a medium whose refractive index is 1 (such as air) and the films S1 to S4, then corresponds to the direction of the columnar element M1. That is, the optical axis is inclined at an angle according to the refractive index of the oblique deposition film, from the direction of the columnar element. The directions for deposition of the oblique deposition films S1 to S4 are not perpendicular to the deposition surface SO, and are different from each other such that the directions of the columnar elements M1 to M4 are different from each other. Accordingly, an azimuth of the optical axis of the each film S1 to S4 is different from each other when the optical axis is orthogonally projected on the deposition surface S0.

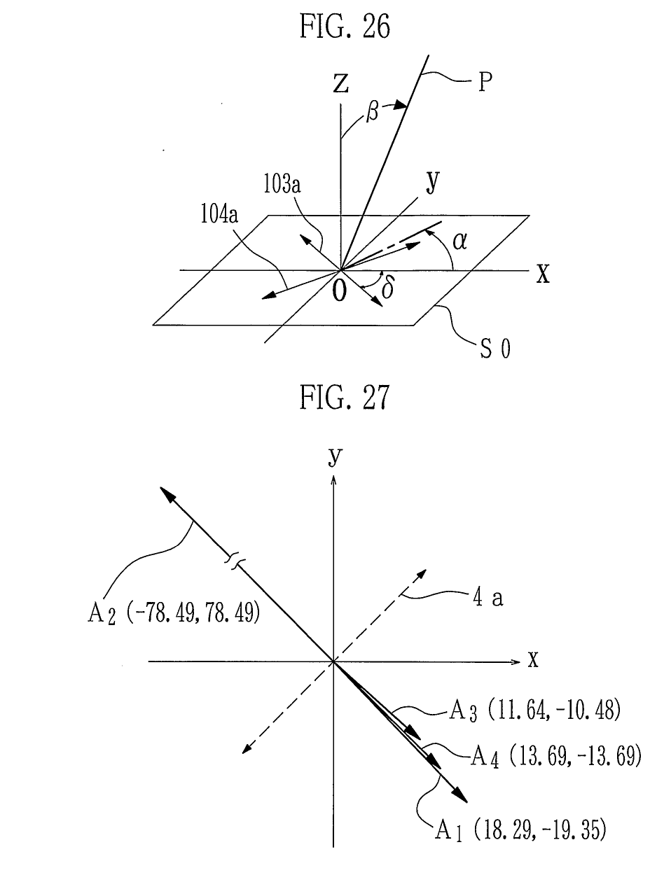

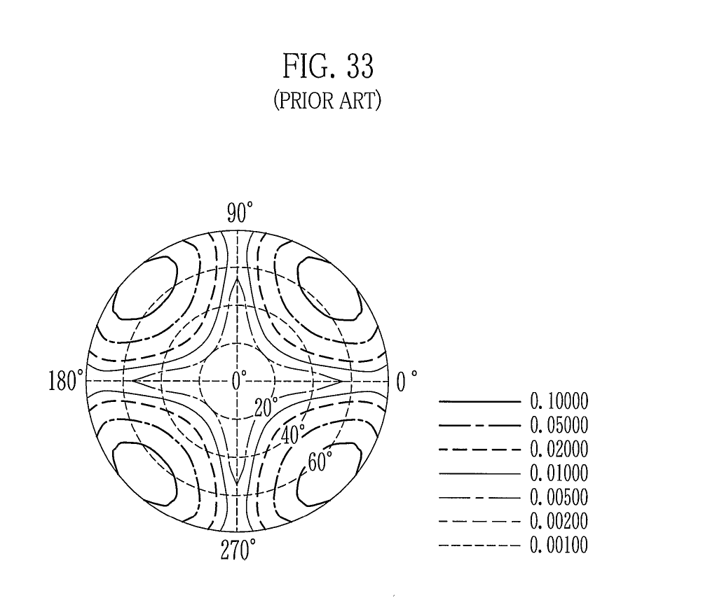

The oblique deposition films S1 to S4 can be formed by the deposition device shown in FIG. 5 as same as the second phase difference compensating layer 14 of the phase difference compensator 6 of the first embodiment. As shown in FIG. 26, the deposition direction P toward the deposition surface S0 is represented by the azimuth α measured from the X-axis in counterclockwise direction and the polar angle β measured from the Z-axis, when orthogonally projected on the X-Y coordinate on the deposition surface S0. The polar angle β is the inclination angle from the Z-axis without directionality of positive and negative, and the azimuth α has directionality with reference to the X-axis. The direction of the X-axis is determined to have an angle δ=45° from the transmission axes 103a and 104a of the polarizing plates 103 and 104. The direction of the X-axis is common in the oblique deposition films S1 to S4. Note that as shown in FIG. 33, since the view angle property of the pair of the polarizing plates 3,4 in the cross nicol configuration has rotational symmetries through 90°, the direction of the X-axis is not limited.

Each of the optical axes of oblique deposition films S1 to S4 is approximately corresponding to the each deposition direction thereof. Each of oblique deposition films S1 to S4 as single layer can show form birefringence effect and can be used as O-plate having positive birefringence. As stated above, the optical axis of each of the oblique deposition films S1 to S4 are not exactly same to the each deposition direction P in a precise sense. However, because effects caused by this slight misalignment is negligible in a practical use, the direction of the optical axis of the each oblique deposition film can be approximated by the azimuth α and the polar angle β.

To form the second phase difference compensating layer 114, the azimuth α and the polar angle β of the each oblique deposition film S1 to S4 can be determined. The refractive index of the deposition material of the each oblique deposition film S1 to S4 is given, and the direction of the optical axis of the each oblique deposition film S1 to S4 is assumed to be approximately corresponding to the deposition direction thereof. Therefore, the optical axis of the each oblique deposition film S1 to S4 can be set at desired value as the direction of the oblique deposition. The inventors made various samples of the second phase difference compensating layer 114 including the oblique deposition films S1 to S4, with controlling the azimuth α and the polar angle β of the each oblique deposition film S1 to S4, and evaluated the view angle dependency of the each sample. As a result, it was confirmed that the view angle property of the second phase difference compensating layer 114 is improved especially when including three or more oblique deposition films, and two of which have respective optical axes projected on the deposition surface 180° apart from each other.

Note that there are various parameters such as the film thickness and the retardation of the each oblique deposition film in addition to the azimuth α and the polar angle β, for improving the view angle property. Although it is extremely difficult to exhaustively examine the relation between these parameters and the view angle property, Experiment 7 as described later was proved to have the superior view angle property for practical purposes. As the deposition material of the second phase difference compensating layer 114, as same as the deposition material of the first phase difference compensating layer 12, materials having sufficient optical transparency independent of wavelength in form of the oblique deposition film, such as TiO₂, SiO₂, ZrO₂ and Ta₂O₃, can be used.

(Experiment 7)

Hereinafter, a concrete experiment of the phase difference compensator 102 of the present invention are explained. After forming the anti-reflection layer same as that in Experiment 1 to 6, the glass substrate was turned inside out in the vacuum chamber, to form the first phase difference compensating layer shown in FIG. 2. The first phase difference compensating layer is a negative C-plate, whose retardation (dΔn) was −341 nm.

The glass substrate, on which the first phase difference compensating layer 12 is formed as described above, was taken out from the vacuum chamber. The glass substrate was washed by acetone and sufficiently dried, and then set in the deposition device shown in FIG. 5. The deposition of the second phase difference compensating layer having four films was performed such that the deposition surface was the uppermost film of the first phase difference compensating layer. The first film was the oblique deposition film S1 in which the azimuth α was −46.5°, the polar angle β was 14° and the retardation (dΔn)_{S1} was 106 nm. The second film was the oblique deposition film S2 in which the azimuth α was 135°, the polar angle β was 45° and the retardation (dΔn)_{S2} was 111 nm. The third film was the oblique deposition film S3 in which the azimuth α was −42°, the polar angle β was 10° and the retardation (dΔn)_{S3} was 87 nm. The fourth film was the oblique deposition film S4 in which the azimuth α was −45°, the polar angle β was 12.5° and the retardation (dΔn)_{S4} was 88 nm. After forming the second phase difference compensating layer including the oblique deposition films S1 to S4, the sample was taken off from the deposition device shown in FIG. 5 and set in the deposition device for performing normal front deposition, to form a three-layer anti-reflection film same as the anti-reflection film 15 shown in FIG. 2.

As the deposition material for the oblique deposition films S1 to S4 of the second phase difference compensating layer 114, ZrO₂ mixed with 10 weight percent of TiO₂ was used. For forming the film, the vacuum chamber was applied the vacuum process until 1×10⁻⁴ Pa, then oxygen gas was putted into the vacuum chamber until 1×10⁻² Pa, to sufficiently oxygenize the film. In Experiment 7 as described above, constructions and parameters of the obtained first and second phase difference compensating layers are shown in Table 7.

TABLE 7

| | | azimuth | polar | (dΔn) |
|---|---|---|---|---|
| Experiment 7 | | α° | angle β° | (nm) |
| second phase | S4 | −45 | 12.5 | 88 |
| difference | S3 | −42 | 10 | 87 |
| compensating | S2 | 135 | 45 | 111 |
| layer | S1 | −46.5 | 14 | 106 |
| first phase | | | | −341 |
| difference | | | | |
| compensating | | | | |
| layer | | | | |

In regard to the each oblique deposition film Si (i=1 to 4), an optical axis vector Pi is determined from a deposition direction P, which is defined by the azimuth α and the polar angle β, and a retardation (dΔn)ₛᵢ defined by the film thickness and the birefringence of the oblique deposition film Si. Generally, the optical axis vector Pi is shown as follows by combination of the retardation (dΔn)ₛᵢ, the azimuth αᵢ and the polar angle βᵢ:
Pi(x, y, z)=((dΔn)ₛᵢ×cos αᵢ×tan βᵢ, (dΔn)ₛᵢ×sin αᵢ×tan βᵢ, (dΔn)ₛᵢ)

A projected vector Ai, which is the optical axis vector Pi orthogonally projected on the X-Y plane shown in FIG. 26, was calculated. The calculation results are as follows:
A₁(x, y)=(18.29, −19.35)
A₂(x, y)=(−78.49, 78.49)
A₃(x, y)=(11.64, −10.48)
A₄(x, y)=(13.69, −13.69)
FIG. 27 is an illustration of these calculation results.

As seen from Table 7 and FIG. 27, the feature of the projected vectors A₁ to A₄ is that the azimuth α of each projected vectors A₂ and A₄, which is approximately equal to the azimuth of the optical axis of each oblique deposition film, is 180° apart from each other. To design the second phase difference compensating layer 114, it is possible to change the parameters such as the number of the oblique deposition film, the thickness of the each film, the azimuth of the optical axis, and the like. By evaluating the examples and calculating the film construction, it is found, as described above, that it is preferable that the second phase difference compensating layer 114 used with the first phase difference compensating layer 12 includes three or more oblique deposition films, and at least two of which have each optical axis whose azimuth is 180° apart from each other. Note that the azimuth of the optical axis can approximate the azimuth of the direction of the oblique deposition. In addition, in this experiment, the direction of the azimuth α of the each oblique deposition film S2, S4 corresponds to the direction of the transmission axis 103a of the polarizing plate 103 in the light incidence side.

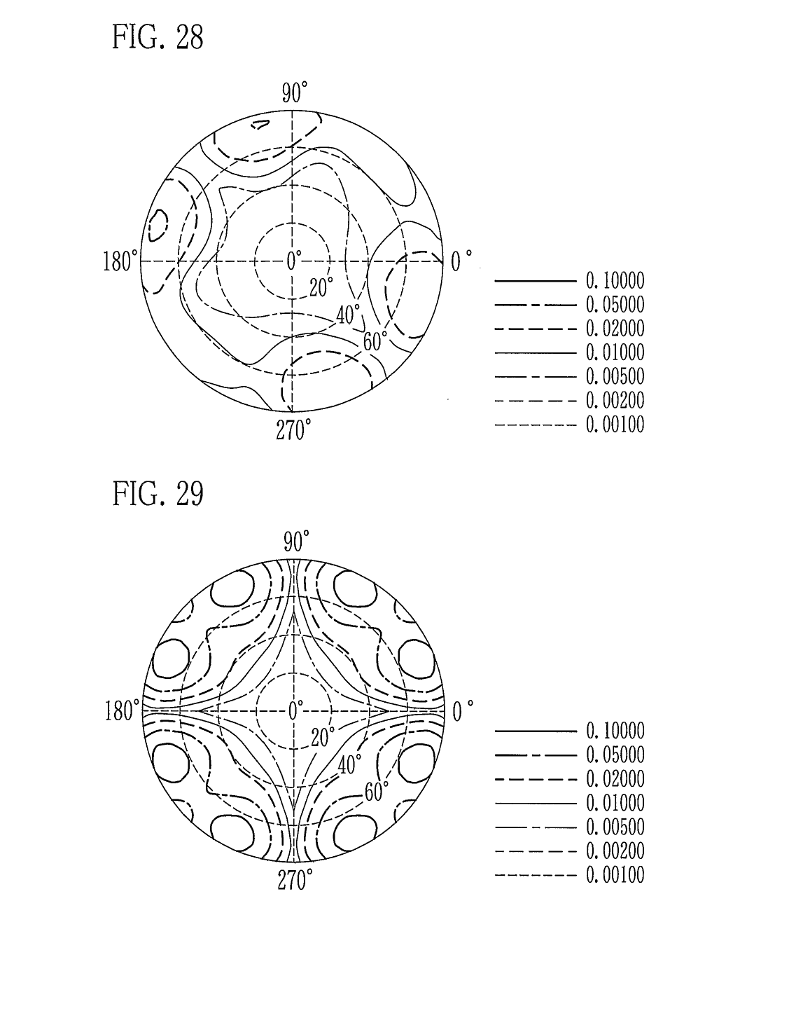

When the phase difference compensator 102 of Experiment 7 is positioned between the polarizing plates 103, 104 as shown in FIG. 23, a light shielding property is as shown in FIG. 28. In the figure, although there remains the view angle dependency, the brightness of the leaking light from the exit side of the polarizing plate 104 is lowered overall. A light shielding property of a sample for comparison is as shown in FIG. 29. In this comparable sample, there are the first phase difference compensating layer 12 whose retardation is −220 nm and the second phase difference compensating layer 114 including single oblique deposition film, whose azimuth of the deposition direction is 135°, and whose retardation is 413 nm. As the comparable sample, it is known that the phase difference compensator, which is the combination of the first phase difference compensating layer of the negative C-plate and the second phase difference compensating layer of the positive O-plate, can improve the light shielding property of the pair of polarizing plates in the cross nicol configuration. However, it is confirmed that the phase difference compensator of Experiment 7 can more effectively improve the light shielding property.

To design the phase difference compensator of the present invention including the first phase difference compensating layer 12 and the second phase difference compensating layer 114, there are enormous combinations of the parameters, for obtain the preferable light shielding property, because there are many parameters such as the retardation determined by the birefringence and the thickness of each film of the first phase difference compensating layer 12, the number of films in the second phase difference compensating layer 114, the azimuth of the optical axis (azimuth of the oblique deposition), the birefringence and the thickness of each film of the second phase difference compensating layer 114. However, it is clear that the light shielding property is effectively improved when the first phase difference compensating layer 12 includes three or more oblique deposition films, and at least two of which have each optical axis whose azimuth is 180° (azimuth of the oblique deposition is 180°) apart from each other.

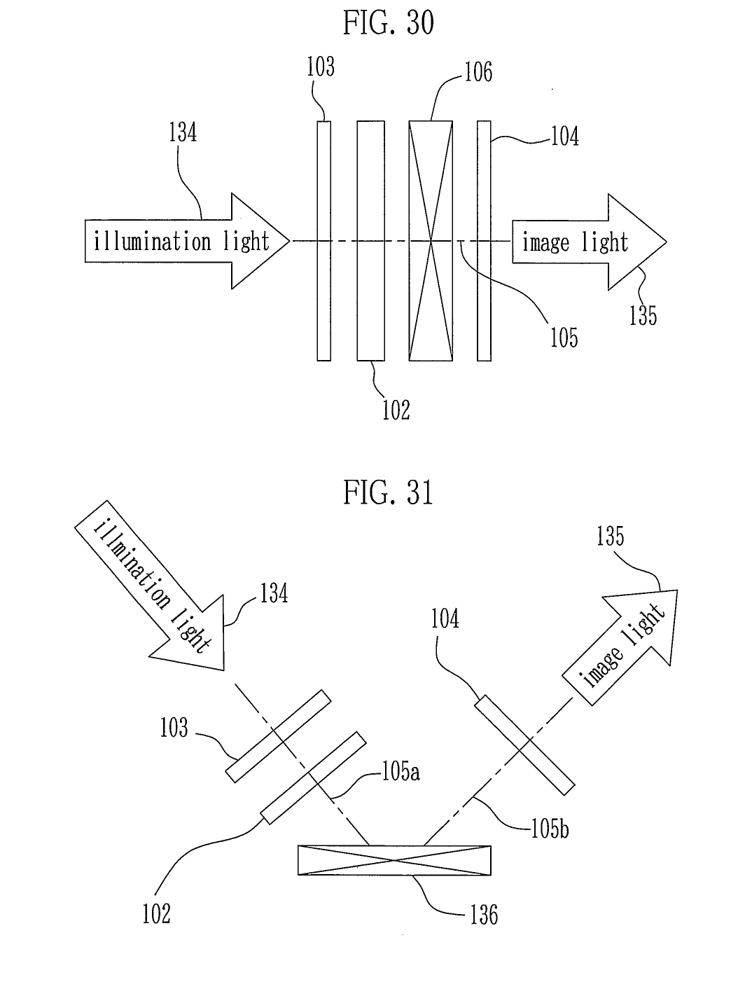

As shown in FIG. 30, the phase difference compensator 102 can be preferably applied to the liquid crystal display. As the liquid crystal element for displaying images, the TN liquid crystal element 106 is used. The phase difference compensator 102 of the present invention in inserted between the polarizing plate 103 in the light incident side and the TN liquid crystal element 106. The polarizing plate 103 in the light incident side and the polarizing plate 104 in the light exit side are in the cross nicol configuration, in which the directions of the transmission axes thereof are crossed at 90°, for using the liquid crystal display in the normally white mode. An illumination light 134 is converted into a linearly polarized light by the polarizing plate 103, and is emanated as an image light 135 by passing through the phase difference compensator 102, the TN liquid crystal element 106 and the polarizing plate 104. When the TN liquid crystal element 106 is in the dark state, even if the illumination light 134 includes luminous flux not parallel to the optical axis 105, generation of leaking light is prevented, and the good light shielding property and the view angle property is obtained, by performance of the phase difference compensator 102.

In this example, there is a need to control the retardation value of the first phase difference compensating layer 12 in the phase difference compensator 102, with considering the birefringence of the liquid crystal molecules contained between the pair of the transparent substrates in the TN liquid crystal element 106. That is, the first phase difference compensating layer 12 is required to compensate the phase difference between the ordinary light and the extraordinary light generated by the birefringence of the liquid crystal molecules in the TN liquid crystal element 106, in addition to compensate the phase difference from the light beam obliquely entered to the polarizing plate 103. The power of compensation of the phase difference can be controlled by controlling the thickness of the first phase difference compensating layer 12 in accordance with the thickness of the liquid crystal cell in the TN liquid crystal element 106.

As shown in FIG. 31, the phase difference compensator 102 can be preferably applied to an off-axis type liquid crystal display which has a reflective type TN liquid crystal element 136 for image displaying. In the reflective type TN liquid crystal element 136, a rear side of a liquid crystal cell is a reflection surface, and an incident optical axis 105a and an output optical axis 105 are not concentric. An illumination light 134 transmitted through the polarizing plate 103 passes through the liquid crystal cell as the linearly polarized incident light. Then the incident light is reflected on the reflection surface and passes through the liquid crystal cell again to become an emanated light. In consideration of using in the normally white mode, the thickness of the liquid crystal cell is determined such that when the reflective type TN liquid crystal element 136 is in the dark state, polarization directions of the incident light turns 90° while becoming the emanated light. In addition, the polarizing plate 103 in the light-incident side and the polarizing plate 104 in the light exit side are in the cross nicol configuration.

Also in the off-axis type of liquid crystal display, when the reflective type TN liquid crystal element 136 is in the dark state, generation of leaking light from the polarizing plate 104 is prevented, and the view angle property is obtained, by performance of the phase difference compensator 102. As same as the example of FIG. 30, in this example, there is a need to control the retardation value of the first phase difference compensating layer 12 in the phase difference compensator 102, with considering the birefringence of the liquid crystal molecules in the reflective type TN liquid crystal element 136. Note that when controlling the thickness of the first phase difference compensating layer 12, there is a need to consider that an optical path length in the liquid crystal cell is twice as the thickness of the cell in the reflective type TN liquid crystal element 136.

The phase difference compensator of the second embodiment of the present invention can be also applied to the full-color direct view type liquid crystal display having the single-panel of the TN liquid crystal element as the display element, when the reference wavelength is set at for example 550 nm for forming the first and second phase difference compensating layers. Also in this case, it is preferable that the three types of the phase difference compensators having different film constructions, corresponding to the each color filter incorporated in the TN liquid crystal element, are provided.

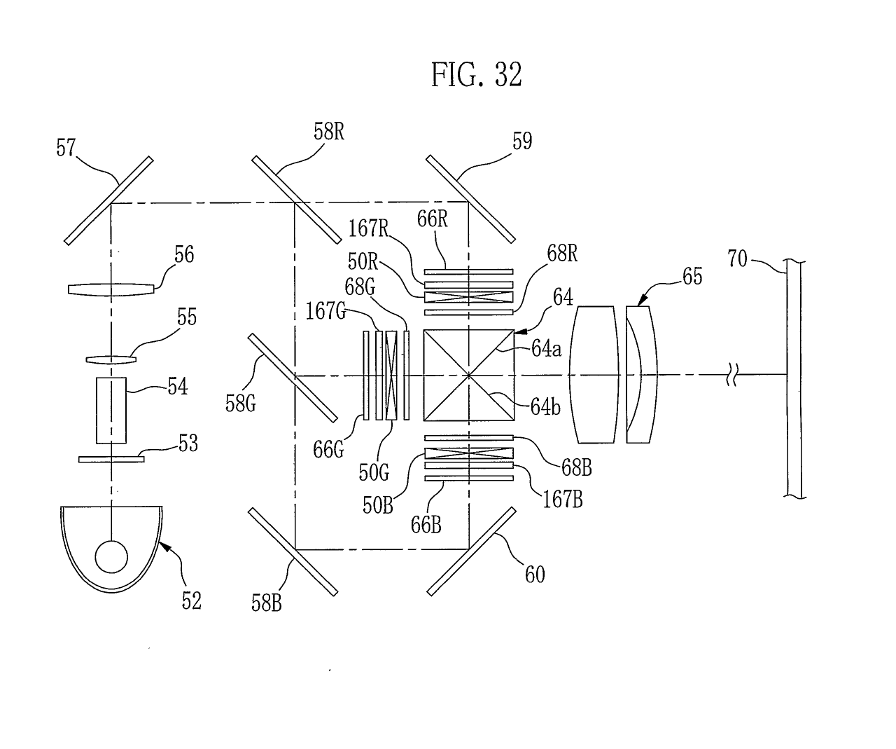

In addition, to change the film construction of the phase difference compensator according to the reference wavelength of the each component color light is effectively applied to a three-panel type liquid crystal projector including three TN liquid crystal element elements corresponding to each component color light. The construction of the three-panel type liquid crystal projector is schematically shown in FIG. 32.

A construction of the liquid crystal projector shown in FIG. 32 is basically same as the liquid crystal projector shown in FIG. 17, but the phase difference compensators 167R, 167G, 167B of the second embodiment of the present invention are respectively provided in the light incident surface side of the liquid crystal elements 50R, 50G, 50B. As described above, each of the phase difference compensators 167R, 167G, 167B includes the first phase difference compensating layer and the second phase difference compensating layer, for respectively compensating the phase difference of each color of the liquid crystal elements 50R, 50G, 50B. In addition, the phase difference compensators 167R, 167G, 167B improve the light shielding performance by the polarizing plates 66R, 66G, 66B and the polarizing plates 68R, 68G, 68B in the cross nicol configuration.

When the phase difference compensator of the second embodiment of the present invention is applied to the three-panel type of color liquid crystal projector, the first phase difference compensating layer is designed as same as the phase difference compensator of the first embodiment. In addition, the second phase difference compensating layer in each of the phase difference compensators 167R, 167G, 167B is also designed to have the specific construction corresponding to the each color channel. The second phase difference compensating layer has the positive retardation as same as the liquid crystal molecules. Accordingly, it is preferable that the total film thickness of the first phase difference compensating layer is increased for an adjustment.

It is expected that the contrast ratio on the screen 70 becomes 1000:1 or more, by using the phase difference compensators 167R, 167G, 167B in which the first and second phase difference compensating layers are optimized as described above. In addition, since the phase difference compensator is formed of only the inorganic material, there is no problem of heat resistance or light resistance. Accordingly, the phase difference compensator of the present invention can be effectively applied to products such as a rear-projection television for home use, which are used in long period of time.

In the phase difference compensator of the second embodiment, as the polarizer for generating the linearly polarized light and the analyzer having light shielding property according to the polarization direction of the light, wire grid polarizer can be used as same as the polarizing plate. In addition, the first phase difference compensating layer can be constituted of a polymer generated from short pitch cholesteric liquid crystal, as same as constituted of the multi deposition films. That is, a layer having the same structure as the cholesteric liquid crystal, whose pitch of a spiral of the liquid crystal molecules is between 1/10 and ⅕ of the light wavelength, and whose spiral axis is perpendicular to the substrate, is known to perform as the negative C-plate. For example, it is formed as described below. At first, a surface of the substrate is processed to have an orientation to which the long axis of the liquid crystal molecules is parallel. Next, the cholesteric liquid crystal having polymerizable molecular structure is coated on the substrate to form the above described cholesteric structure. Then photopolymerization process or the like is applied to the cholesteric liquid crystal to eliminate the fluidity.

In addition, the positive C-plate can be applied to the first phase difference compensating layer. In this case, at first, a surface of the substrate is processed to have an orientation to which the long axis of the liquid crystal molecules is perpendicular. Next, the rodshaped liquid crystal monomer having polymerizable molecular structure is coated on the substrate to form a monodomain orientation film. Then the photopolymerization process or the like is applied to the monodomain orientation film to eliminate the fluidity.

As same as the phase difference compensator of the first embodiment, as the substrate for forming the phase difference compensator of the second embodiment, some transparent inorganic materials can be used as same as the glass substrate. The preferable materials are a sapphire substrate and a quartz substrate which have high heat conductance, to apply to the liquid crystal projector. In addition, it is possible that the first phase difference compensating layer and the second phase difference compensating layer are formed respectively on individual transparent substrates. And lenses, prisms, some kind of filters, and substrates of the liquid crystal elements which are in the optical system can be used as the transparent substrates for the phase difference compensating layers.

### INDUSTRIAL APPLICABILITY

The present invention is preferably applied to devices for utilizing polarized light, especially to devices associated to liquid crystals.

1. A phase difference compensator used in combination with a TN liquid crystal cell, for compensating angle dependency of phase difference of light passing through a liquid crystal layer in said TN liquid crystal cell, said phase difference being caused by birefringence of said liquid crystal layer, said phase difference compensator comprising:
a first phase difference compensating layer including multi-layer films each of which is a form birefringence body formed of inorganic material, for compensating phase difference caused by liquid crystal molecules in vertical orientation in said liquid crystal layer; and
a second phase difference compensating layer including multi-layer films each of which is a form birefringence body formed of inorganic material, for compensating phase difference caused by liquid crystal molecules in hybrid orientation in said liquid crystal layer.

2. A phase difference compensator described in claim 1, wherein at least one of said first and second phase difference compensating layers includes multi-layer films each of which is formed by vacuum deposition method.

3. A phase difference compensator described in claim 1, wherein said second phase difference compensating layer includes plural kinds of stacked oblique deposition films which are different in at least one of an azimuth and a polar angle of a deposition direction toward a deposition surface.

4. A phase difference compensator described in claim 1, wherein said second phase difference compensating layer includes three or more stacked oblique deposition films.

5. A phase difference compensator described in claim 1, wherein said second phase difference compensating layer includes plural stacked oblique deposition films,
and when an azimuth of a deposition direction of each oblique deposition films is determined to be different from an azimuth of said liquid crystal molecules given by an orientation film of said TN liquid crystal cell, each optical axis vector is determined from said azimuth, a polar angle and a retardation of each oblique deposition film, and a synthetic vector A of said optical axis vectors is orthogonally projected on a deposition surface, X and Y coordinate value (Ax, Ay) satisfies following formulae:
−200 nm≦Ax≦200 nm and
−500 nm≦Ay≦0 nm

6. A phase difference compensator described in claim 1, a relation between a retardation dΔn of said first phase difference compensating layer and a product (dΔn)_{LC} of said birefringence and a thickness d of said liquid crystal layer of said TN liquid crystal cell being as follows:
−2×(dΔn)_{LC}≦(dΔn)≦−0.5×(dΔn)_{LC}

7. A phase difference compensator described in claim 1, wherein said first phase difference compensating layer is composed of two kinds of deposition films with different refractive indices that are alternately layered, and an optical thickness of each of said deposition films is 1/100 to ⅕ of a reference wavelength.

8. A phase difference compensator described in claim 1, further comprising an anti-reflection layer being provided at a light incident surface side and/or a light exit surface side of said phase difference compensator.

9. A liquid crystal display comprising a TN liquid crystal cell and said phase difference compensator described in claim 1 said phase difference compensator being positioned at a light incident surface side and/or a light exit surface side of said TN liquid crystal cell.

10. A liquid crystal projector comprising a TN liquid crystal cell, said phase difference compensator described in claim 1 and a projection lens for projecting light modulated by said TN liquid crystal cell, said phase difference compensator being positioned at a light incident surface side and/or a light exit side of said TN liquid crystal cell.

11. A liquid crystal projector described in claim 10, comprising:
three said TN liquid crystal cells each of which displays an image of each of three component color lights; and
three said phase difference compensators each of which corresponds to said each TN liquid crystal cell, said three phase difference compensators including at least two kinds of said phase difference compensators each of which has a retardation different from each other according to a reference wavelength of said each component color light.

12. A phase difference compensator used between a pair of polarizing elements in a cross nicol configuration, comprising:
a transparent substrate vertical to an optical axis which is vertical to said pair of polarizing elements;
a first phase difference compensating layer supported by said transparent substrate, an optical axis thereof being vertical to said transparent substrate; and
a second phase difference compensating layer including three or more stacked films each of which has an optical axis inclined to a normal of said transparent substrate, directions of said optical axes of two of said stacked films orthogonally projected on said transparent substrate being approximately 180° apart from each other.

13. A phase difference compensator described in claim 12, wherein said first and second phase difference compensating layers are formed of inorganic material.

14. A phase difference compensator described in claim 13, wherein said stacked films in said second phase difference compensating layer are oblique deposition films.

15. A phase difference compensator described in claim 13, wherein said first phase difference compensating layer is composed of two kinds of deposition films with different refractive indices that are alternately layered, and an optical thickness of each of said deposition films is 1/100 to ⅕ of a reference wavelength.

16. A phase difference compensator described in claim 13, a direction of an optical axis of one of said layered film in said second phase difference compensating layer, orthogonally projected on said transparent substrate, being same to a direction of a transmission axis of said polarizing element in a light incident side of said phase difference compensator.

17. A phase difference compensator described in claim 12, further comprising an anti-reflection layer being provided at a light incident surface side and/or a light exit surface side of said phase difference compensator.

18. A light modulating system comprising said phase difference compensator described in claim 16 and a liquid crystal cell disposed at a light exit surface side of said phase difference compensator.

19. A liquid crystal display comprising a transmissive type liquid crystal cell and said phase difference compensator described in claim 16, said liquid crystal cell being positioned at a light exit surface side of said phase difference compensator.

20. A liquid crystal projector comprising a transmissive type liquid crystal cell, said phase difference compensator described in claim 16 and a projection lens for projecting light modulated by said liquid crystal cell, said liquid crystal cell being positioned at a light exit surface side of said phase difference compensator.

21. A liquid crystal projector comprising a reflective type liquid crystal cell, said phase difference compensator described in claim 16 and an off-axis type projection lens for projecting light modulated by said liquid crystal cell, said liquid crystal cell being positioned at a light exit surface side of said phase difference compensator.
